(19) United States
(12) Patent Application Publication
(10) Pub. No.: US 2014/0084688 A1
(43) Pub. Date: Mar. 27, 2014

(54) METHOD AND APPARATUS FOR WIRELESS POWER TRANSMISSION

(71) Applicant: Samsung Electronics Co. LTD, Suwon-si (KR)

(72) Inventors: Ioannis Tzanidis, Plano, TX (US); Umar Azad, San Jose, CA (US); Sridhar Rajagopal, Plano, TX (US)

(73) Assignee: Samsung Electronics Co. LTD, Suwon-si (KR)

(21) Appl. No.: 14/028,254

(22) Filed: Sep. 16, 2013

Related U.S. Application Data
(60) Provisional application No. 61/704,378, filed on Sep. 21, 2012.

(51) Int. Cl. H01F 38/14

(52) U.S. Cl. CPC H01F 38/14
USPC 307/42

(57) ABSTRACT

A method for wireless power transmission includes establishing respective wireless communication link between a coordinating transmitter and each receiver. The method further includes measuring respective mutual impedance between a coordinating transmitter and each receiver by applying a voltage to the coordinating transmitter and configuring each receiver to measure an induced current in response to the applied voltage. The method calculates respective matching impedance for the coordinating transmitter and each receiver based on corresponding mutual impedance. The method transmits the respective matching impedance to each receiver to enable each receiver to adjust to have the respective matching impedance. The method adjusts the coordinating transmitter to have the respective matching impedance.

### CROSS-REFERENCE TO RELATED APPLICATION(S) AND CLAIM OF PRIORITY

The present application claims priority to U.S. Provisional Patent Application Ser. No. 61/704,378, filed Sep. 21, 2012, entitled “METHOD AND APPARATUS FOR OPTIMIZING WIRELESS POWER TRANSFER EFFICIENCY IN A NETWORK CONSISTING OF MULTIPLE TRANSMITTERS, RECEIVERS AND REPEATERS”. The content of the above-identified patent document is incorporated herein by reference.

### TECHNICAL FIELD

The present disclosure relates to wireless power transfer networks using magnetic resonance, and more particularly, to wireless power transfer networks with a wireless communication link between devices to share information to improve an optimal power transfer efficiency.

### BACKGROUND

Wireless power transfer, also referred to as wireless energy transfer or wireless charging, to electronic devices is an area of growing interest. In wireless power transfer networks comprised of multiple devices, such as transmitters, receivers, and repeaters, one of the challenges is that of impedance tuning of the devices for accomplishing improved power transfer efficiencies.

### SUMMARY

A method for wireless power transmission includes establishing respective wireless communication link between a coordinating transmitter and each receiver. The method includes measuring respective mutual impedance between a coordinating transmitter and each receiver by applying a voltage to the coordinating transmitter and configuring each receiver to measure an induced current in response to the applied voltage. The method further calculates respective matching impedance for the coordinating transmitter and each receiver based on corresponding mutual impedance. The method transmits the respective matching impedance to each receiver to enable each receiver to adjust to have the respective matching impedance. The method adjusts the coordinating transmitter to have the respective matching impedance.

A coordinating transmitter for wireless power transmission comprises a processing circuitry configured to establish respective wireless communication link between the transmitter and each receiver. The circuitry is configured to measure respective mutual impedance between a coordinating transmitter and each receiver by applying a voltage to the coordinating transmitter and configuring each receiver to measure an induced current in response to the applied voltage. The circuitry is configured to calculate respective matching impedance for the coordinating transmitter and each receiver based on corresponding mutual impedance. The circuitry is configured to transmit the respective matching impedance to each receiver to enable each receiver to adjust to have the respective matching impedance. The circuitry is configured to adjust the coordinating transmitter to have the respective matching impedance.

A method for wireless power transmission in a wireless power transfer network comprises establishing respective wireless communication link between devices including a coordinating transmitter and at least one receiver. The method measures self-impedances of each device by configuring each device to switch to State-1, where the device applies a voltage to its inductive resonator and measure a respective current, and the other device(s) to switch to State-4, where its inductive resonator is open circuited. The method measures mutual impedances of the devices in pairs by switching one device of each pair to State-2, where the device applies a voltage to its inductive resonator, switching the other device of each pair to State-3, where the device measures the current induced to its inductive resonator as a result of the voltage applied to the one device's inductive resonator, while a non-paired device(s) in the wireless power transfer network is switched to State-4, where its inductive resonator is open circuited. The method configures the receivers to transmit the respective applied voltage and measured induced current to the coordinating transmitter. The method includes receiving, by the coordinating transmitter, the respective voltage and measured current from each device via the wireless communication link. The method calculates respective matching impedance for the coordinating transmitter and each receiver based on corresponding self-impedance and mutual impedance. The method transmits the respective matching impedance to each receiver to enable each receiver to adjust to have the respective matching impedance. The method adjusts the coordinating transmitter to have the respective matching impedance. At least one receiver is a repeater located between the transmitter and the other receiver(s). At least one repeater is located between the transmitter and the receiver(s).

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a high-level block diagram of a wireless power transmission network according to embodiments of the present disclosure;

FIGS. 2A and 2B illustrate a wireless power transfer network including a transmitter and a receiver according to embodiments of the present disclosure;

FIGS. 3A, 3B, 3C, 3D and 3E illustrate the various wireless power transfer networks according to embodiments of the present disclosure;

FIG. 4 illustrates various inductive resonators according to embodiments of the present disclosure;

FIGS. 5A and 5B illustrate example loop resonators according to embodiments of the present disclosure;

FIGS. 6A and 6B illustrate equivalent electrical circuits of repeater resonators according to embodiments of the present disclosure;

FIGS. 7A, 7B, 7C and 7D illustrate the several technologies for tuning the impedance of the inductive resonators of the participating devices according to embodiments of the present disclosure;

FIG. 8 is a high-level flowchart illustrating the process of signaling for a tuning operation according to embodiments of the present disclosure;

FIGS. 9A, 9B, 9C and 9D are equivalent circuits of the devices in State-1, State-2, State-3 and State-4, respectively, according to embodiments of the present disclosure;

FIGS. 10A, 10B, 10C and 10D illustrate wireless communication links established in the various wireless power transfer networks according to embodiments of the present disclosure;

FIG. 11 illustrates the wireless power transmission network including a single transmitter and a single receiver with no repeater according to embodiments of the present disclosure;

FIG. 12 illustrates a graph plotting optimal power transmission efficiency versus k\sqrt{Q₁ᵢₙₜQ₂ᵢₙₜ} according to embodiments of the present disclosure;

FIG. 13 illustrates the wireless power transmission network including a transmitter and two non-coupled receivers according to embodiments of the present disclosure;

FIG. 14 illustrates a graph of wireless power transmission efficiency for a transmitter and two non-coupled receivers according to embodiments of the present disclosure;

FIGS. 15A, 15B and 15C, respectively, illustrate the efficiency contours for efficiency at receivers Rx₂, Rx₃ and total efficiency of the network according to embodiments of the present disclosure;

FIG. 16 illustrates the wireless power transmission network including a single transmitter and multiple non-coupled receivers according to embodiments of the present disclosure;

FIG. 17 illustrates a wireless power transmission network including a transmitter, a receiver and a repeater between the transmitter and receiver according to embodiments of the present disclosure;

FIG. 18 illustrates efficiency contours for a wireless power transfer network consisting of a single repeater between a transmitter and a receiver according to embodiments of the present disclosure;

FIG. 19 illustrates efficiency graphs provided by the case with a repeater over the case without a repeater according to embodiments of the present disclosure;

FIG. 20 illustrates a wireless power transmission network including a transmitter, a receiver and multiple repeaters according to embodiments of the present disclosure; and

FIG. 21 illustrates the wireless power transmission network including a transmitter and two coupled receivers according to embodiments of the present disclosure.

### DETAILED DESCRIPTION

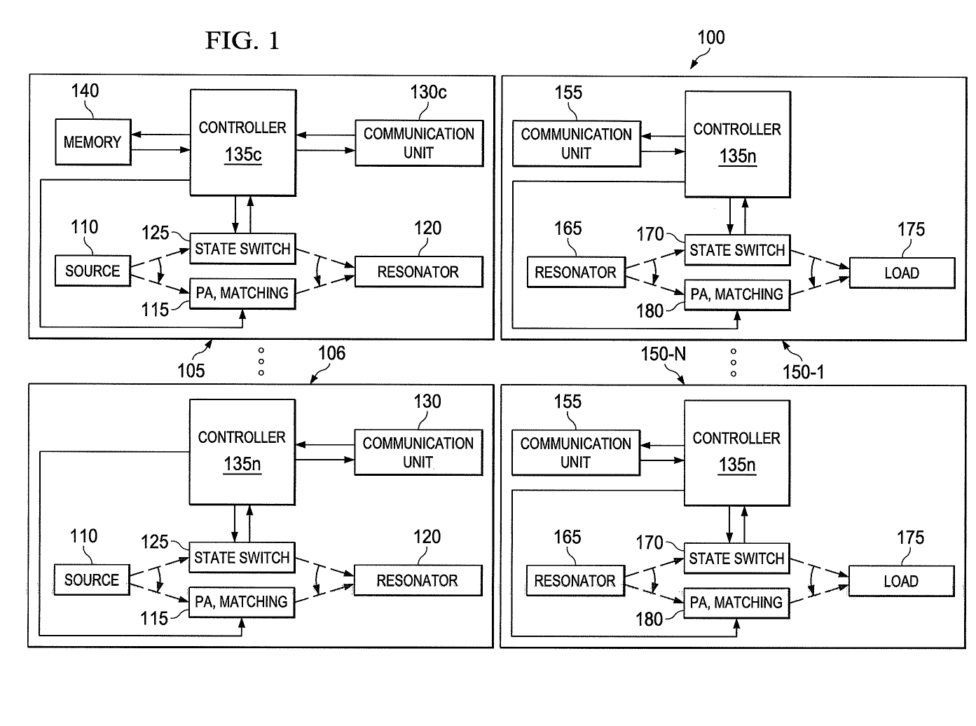

FIGS. 1 through 21, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless power transfer network.

The following documents and standards descriptions are hereby incorporated into the present disclosure as if fully set forth herein: Inductively coupled wireless power transfer networks have been used in many applications ranging from drill machines (Thierry Bieler, Marc Perrottet, Valérie Nguyen, and Yves Perriard, “Contactless Power and Information Transmission”, IEEE transactions on industry applications, vol. 38, No. 5, September-October 2002), implantable devices (K. Chen, Z. Yang, L. Hoang, J. Weiland, M. Humayun, and W. Liu, “An Integrated 256-Channel Epiretinal Prosthesis”, IEEE Journal of Solid-State Circuits, vol. 45, no. 9, pp. 1946-1956, September 2010), RFIDs (K. Finkenzeller, RFID Handbook, Fundamentals and Applications in Contactless Smart Cards and Identifications, 2nd edition, John Wiley & Sons, 2003), health monitoring devices (S. Esko, K. Jouni, P. Juha, Y. Arto and K. Ilkka, “Application of Near Field Communication for Health Monitoring in Daily Life”, IEEE Annual International Conference on Engineering in Medicine and Biology Society, pp. 3246-3249, August 2006), battery charger of cellular phones (C. Kim, D. Seo, J. Park, and B. Cho, “Design of a Contactless Battery Charger for Cellular Phone”, WEE transaction on Industrial Electronics, vol. 48, no. 6, pp. 1238-1247, December 2001), portable consumer electronics (S. Hui and W. Ho, “A new Generation of Universal Contactless Battery Charging Platform for Portable Consumer Electronic Equipment”, IEEE Transaction on Power Electronics., vol. 20, no. 3, pp. 620-627, May 2005) and electric vehicles (J. G. Bolger, F. A. Kirsten and L. S. Ng, “Inductive Power Coupling for an Electric Highway System”, IEEE Vehicular Technology Conference, 29th, 1978). High power transfer efficiency is desired in the aforementioned applications in order to minimize the transmitted power and thus the interference with other electronic devices in the vicinity, keep magnetic fields within human exposure safety limits (IEEE Standards for Safety Levels With Respect to Human Exposure to Radio Frequency Electromagnetic Fields, 3 kHz to 300 GHz, IEEE standard C95.1, 1999) and avoid excessive heat generation at the transmitter.

There exists an upper limit on the efficiency of a wireless power transfer network consisting of a single transmitter and receiver. This limit is defined by the quality factor of the resonators and the coupling coefficient between them. Several approaches have been followed, such as: the coupled mode theory (André Kurs, Aristeidis Karalis, Robert Moffatt, J. D. Joannopoulos, Peter Fisher and Marin Soljacic, “Wireless Power Transfer via Strongly Coupled Magnetic Resonances”, Science express, vol. 317. no. 5834, pp. 83-86, 6 Jul. 2007), equivalent circuit model (Mehdi Kiani and Maysam Ghovanloo, “The Circuit Theory Behind Coupled-Mode Magnetic Resonance-Based Wireless Power Transmission”, IEEE Transactions on Circuits and Systems, vol. 59, No. 8, August 2012), and Z-parameters describing the interaction between two small antennas in terms of TE10/TM10 spherical modes (JaeChun Lee, Sangwook Nam, “Fundamental Aspects of Near-Field Coupling Small Antennas for Wireless Power Transfer”, IEEE Transactions on Antennas and Propagation, vol. 58, issue 11, pp. 3442-3449, November 2010).

There exists an optimum load impedance for receiving devices and source impedance for transmitting devices that maximizes power transfer efficiency from the source to the load. In typical stationary charging applications, such as a charging dock station, or a charging pad (e.g., charging mat), impedance matching for optimum power transfer can be done a priori.

That is, because of the limited mobility allowed for each device while charging receivers, limited variation exists in the coupling between the transmitting and receiving devices. Therefore, the optimum impedance of the source and load can be known before hand and incorporated in the design of their matching networks.

However, in a dynamic charging environment such as a wireless power transfer network where the position, orientation and coupling of transmitting and receiving devices changes, or multiple devices enter and exit the network, a large variation in impedances can result. Therefore, there is great need for adaptive impedance tuning. Knowledge of the optimum impedance setting for all devices in a wireless power transfer network is useful for designing the impedance matching networks, assessing the impact on power amplifier efficiency at the transmitting devices, and determining the voltage range of the regulators at the receiving devices.

A configuration for improving the efficiency of power transfer from the source to the resonator connected to it (i.e., impedance matching at the source resonator) was proposed in U.S. patent application Ser. No. 12/986,018, the contents of which are hereby incorporated by reference, in which it varies the duty cycle of switching power amplifier driving the source device resonator. However, a critical aspect of wireless power transfer network design is the knowledge of the optimal source and load impedances that lead to maximum efficiency, and their variation with coupling for a wireless power transfer network involving multiple transmitters, receivers and repeaters.

FIG. 1 is a high-level block diagram of a wireless power transfer network 100 according embodiments of the present disclosure. In the embodiments, the wireless power transfer network 100 includes a coordinating transmitter 105, a non-coordinating transmitter 106 and receivers 150-1 to 150-n. The embodiment of the wireless power transfer network shown in FIG. 1 is for illustration only. Other embodiments of wireless power transfer network could be used without departing from the scope of the present disclosure. The wireless power transfer network includes at least one coordinating transmitter and one receiver. In certain embodiments, the wireless power transfer network can add a non-coordinating transmitter(s), a repeater(s) and/or a receiver(s).

The wireless power transfer network 100 includes a coordinating transmitter 105, non-coordinating transmitter 106 and receivers 150-1 to 150-n. Near zone magnetic field is formed between the transmitters 105, 106 and the receivers 150-1 to 150-N and energy is transferred from the transmitter to the receiver via the near magnetic field.

The transmitters 105, 106 include a power source 110, a matching circuit 115 to adjust an impedance, and a transmit (Tx) inductive resonator 120 to form a near zone magnetic field. For instance, the inductive resonator includes a closed loop conductor forming an inductor plus an external capacitor used to create resonance at a certain frequency. The transmitters 105, 106 further include a state switch 125 to switch the states of the transmitters at the respective stage of the turning algorithm. The wireless communication unit 130 establishes a wireless communication link with the other devices in the network.

The coordinating transmitter 105 includes a controller 135c that coordinates the wireless communication between devices, controls the state switch and calculates the matching impedances for the devices in the network according to the tuning algorithm stored in a memory 140. The communication unit 130c transmits the state signals and the impedances to the other devices in the network.

The receivers 150-1 to 150-N include a resonator 165, a matching network 180, and a load 175. The Receivers resonate in the presence of the magnetic field to receive power and transfer it to a load 175 to charge a battery or power a device coupled electrically to the receivers. The wireless communication unit 155 establishes a wireless communication link with the coordinating transmitter 105 to feedback the information regarding, for example, a self-impedance and a mutual impedance to the coordinating transmitter 105 and receive the impedance to adjust the matching network 180 so that optimum charging conditions (e.g., current, voltage) can be created at load 175 such as a battery or a device to charge.

The receivers 150-1 to 150-N further include a state switch 170 to switch the states of the receiver at the respective stage of the turning algorithm.

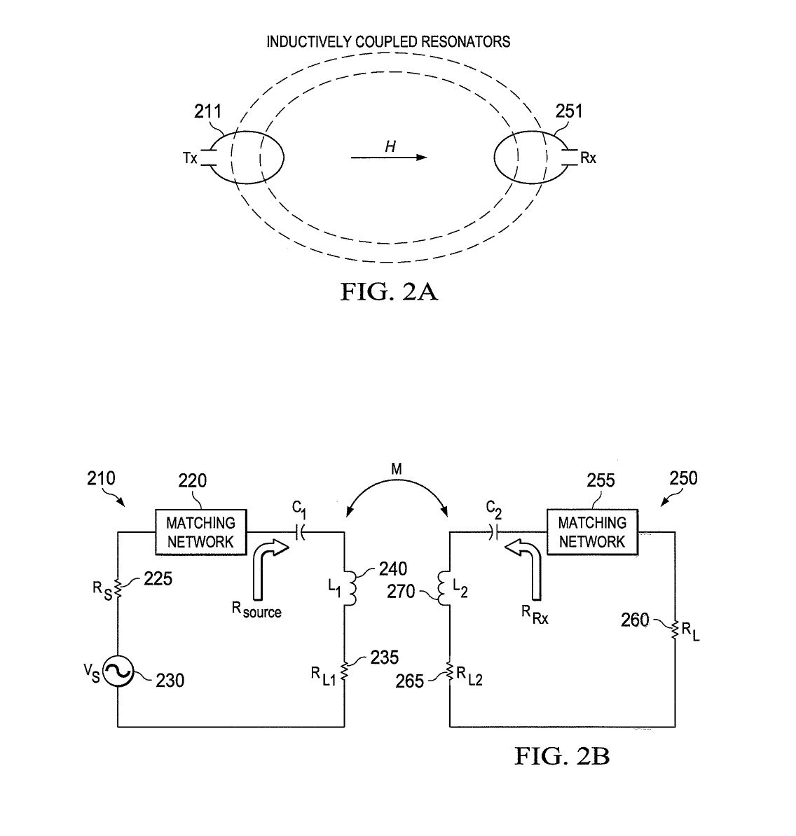

FIGS. 2A and 2B illustrate the wireless power transfer network including a transmitter 210 and a receiver 250 according to embodiments of the present disclosure. The embodiments of the wireless power transfer network shown in FIGS. 2A to 2B are for illustration only. Other embodiments of wireless power transfer network could be used without departing from the scope of the present disclosure.

FIG. 2A illustrates magnetic resonant coupling between coupled Tx resonator 211 and Rx resonator 251 according to embodiments of the present disclosure. FIG. 2B illustrates an equivalent circuit model of the transmitter 210 and receiver 250. External capacitors C₁ and C₂ are added to both inductive resonators L₁, L₂ so that transmitter 210 and receiver 250 resonate at same resonant frequency in order to have optimal coupling sensitivity. The transmitter impedance R_{source} seen by the Tx resonator is transformed to Rₛ, and the receiver impedance R_{Rx} seen by the Rx resonator is transformed to the load impedance R_{L} for further calculating a resonant coupling efficiency.

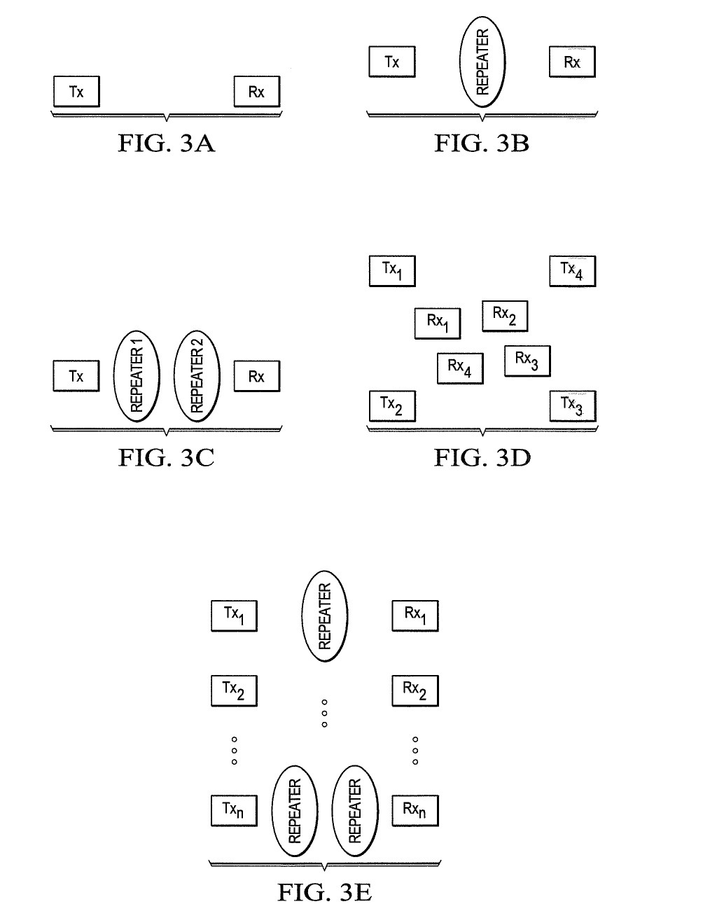

FIGS. 3A, 3B, 3C, 3D and 3E illustrate various wireless power transfer networks according to embodiments of the present disclosure. The embodiments of the wireless power transfer network shown in FIGS. 3A, 3B, 3C, 3D and 3E are for illustration only. Other embodiments of wireless power transfer network could be used without departing from the scope of the present disclosure.

The wireless power transmission between a transmitter and a receiver can be extended to a wireless power transfer network comprised of multiple devices. In the example shown in FIG. 3A, the network includes a single transmitter and a single receiver with no repeater, such as has been described with reference to FIGS. 2A and 2B. In the example shown in FIG. 3B, a single transmitter and single receiver are coupled with a repeater between them, where a transmitter can be wirelessly linked to a repeater and a receiver respectively. In the example shown in FIG. 3C, a transmitter and a receiver are coupled with repeater 1 and repeater 2, between them, where the transmitter can be wirelessly linked to a repeater 1 and a receiver 2 respectively. In the example shown in FIG. 3D, a network includes a coordinating transmitter Tx₁, non-coordinating transmitter Tx₂ to Tx₄, and receivers Rx₁ to Rx₄. In the example shown in FIG. 3E, a network includes multiple transmitters, multiple receivers and multiple repeaters. The tuning algorithm according to embodiments of the present disclosure can be applied to any type of inductive resonators.

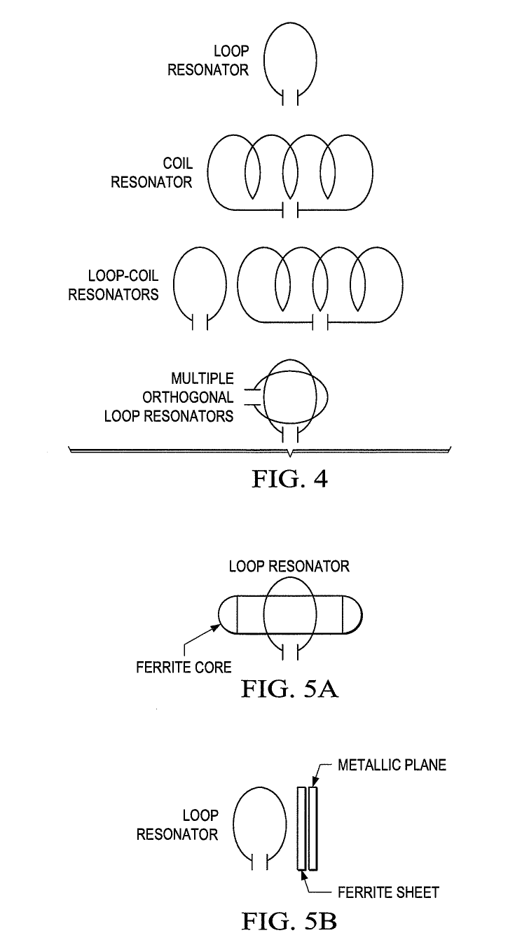

FIG. 4 illustrates various inductive resonators according to embodiments of the present disclosure. The embodiments of the wireless power transfer network shown in FIG. 4 are for illustration only. Other embodiments of wireless power transfer network could be used without departing from the scope of the present disclosure. The inductive resonator can include one of a loop, inductive resonator, or multiple loops and/or inductive resonators fed in and/or out of phase, for orientation-free wireless power transfer.

An inductive resonator can include any closed loop conductor with or without a magnetic core of any shape that provides for some inductance. An external capacitor is connected in series or parallel to the inductors terminals to create resonance at a certain frequency determined by the inductance of the close loop and the value of the external capacitance. As illustrated in FIG. 5A, a ferrite core is used to improve the strength of magnetic field in the axial direction of the loop, whereas in FIG. 5B, a ferrite sheet is placed between loop and the metallic backplane in order to improve the quality factor of the loop, which is degraded due to eddy currents formed on the metallic sheet.

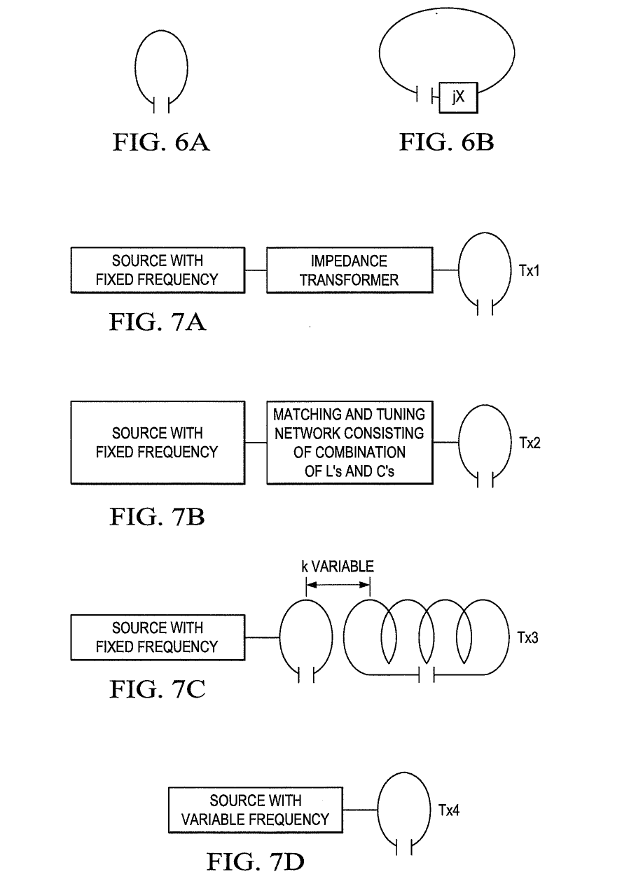

FIGS. 6A and 6B illustrate equivalent electrical circuits of repeater resonators. In order to increase the range of wireless power transfer, passive resonators referred to as repeaters can be placed between the transmitter and receiver resonators. The repeater resonator can have any of the inductive resonator shapes illustrated in FIG. 4. Further, the repeater resonator can either be designed with or without external capacitors, and with or without an external load impedance (jX) as shown in FIGS. 6A and 6B, respectively.

FIGS. 7A, 7B, 7C and 7D illustrate the several technologies for tuning the impedance of the resonators of the participating devices according to embodiments of the present disclosure. In FIG. 7D, transmitter Tx₁ tunes its impedance by varying the operation frequency. In FIG. 7A, transmitter Tx₂ tunes its impedance by varying the turn ratio of a transformer connected between the inductive resonator and the source. In FIG. 7C, transmitter Tx₃ tunes its impedance by varying the coupling between an auxiliary tuner loop resonator and the inductive resonator. In FIG. 7B, transmitter Tx₄ tunes its impedance by using a network of series and/or parallel combinations of inductors and capacitors.

In a wireless power transfer network comprised of multiple transmitters and receivers, the total efficiency can be defined as a sum of weighted individual efficiencies of each receiver. The individual efficiency of a receiver device is the ratio of power received at the load impedance to the total power available by the source(s). When optimizing the efficiency of the wireless power transfer network one could choose to optimize the individual efficiency of some receiver or the total efficiency of the network given by:

ηtotal=α(η1)+β(η2)+γ(η3)+ . . . +δ(ηn) (1)

where α, β, γ, and δ are weighting factors, and η1, η2, η3, . . . , ηn are the individual receiver efficiencies. The weighed factors are determined based on, for example, charging priorities of devices. For instances, the device whose battery level is critically low can have a higher charging priorities. Alternatively, a user can manually configure the charging priorities in the wireless power network, for example, by the weighting factors.

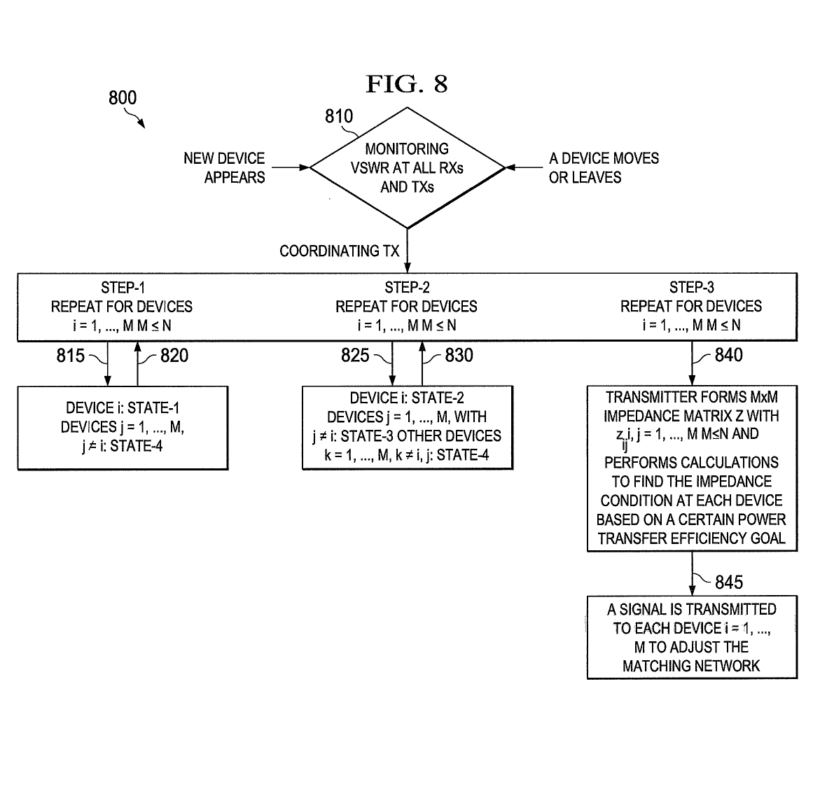

FIG. 8 is a high-level flowchart illustrating for a tuning operation according to embodiments of the present disclosure. While the flowchart depicts a series of sequential operations, unless explicitly stated no inference should be drawn from that sequence regarding specific order of performance, performance of operations or portions thereof serially rather than concurrently or in an overlapping manner, or performance of the operations depicted exclusively without the occurrence of intervening or intermediate operations.

The tuning operation 800 begins with monitoring at least one trigger event to initiate impedance matching process for the devices in the wireless power transfer network in operation 810. In certain embodiment, the trigger event includes when a new receiver enters the network and requests charging from the transmitter, or an existing device exits the wireless power transfer network and requests releasing from the transmitter. In certain embodiments, an existing receiver moves or an external object is placed within the network such that the impedance properties of the network are affected. Such changes can be detected by monitoring the impedance, or reflection coefficient, or Voltage Standing Wave Ratio (VSWR) at the terminals of each device's inductive resonator. In response to detecting a change that is greater than a threshold, the operation initiates the tuning process to adjust the impedance matching networks to provide for the optimal impedance values. In certain embodiments, the tuning operation declines a certain receiver from being charged.

Then, the coordinating transmitter establishes a communication link with each device in the wireless power transfer network. The communication link can be established via, for example, ZIG-BEE, infrared, BLUETOOTH, or any suitable near or far field communication links.

In the embodiment, the number of the devices in the wireless power transfer network is N. The matching algorithm includes three steps: Step-1 consisting of operations 815 and 820, is to acquire diagonal elements of impedance matrix Z; Step-2 consisting of operations 825 and 830 is to acquire off-diagonal elements of impedance matrix Z; and Step-3 consisting of operations 840 is to calculate the optimum impedance setting for each device that maximizes a certain efficiency goal (eg. total efficiency) and adjust matching networks of each device to reflect optimum impedance setting. In certain embodiments, if the self-impedance is known to a coordinating transmitter, Step-1 can be omitted.

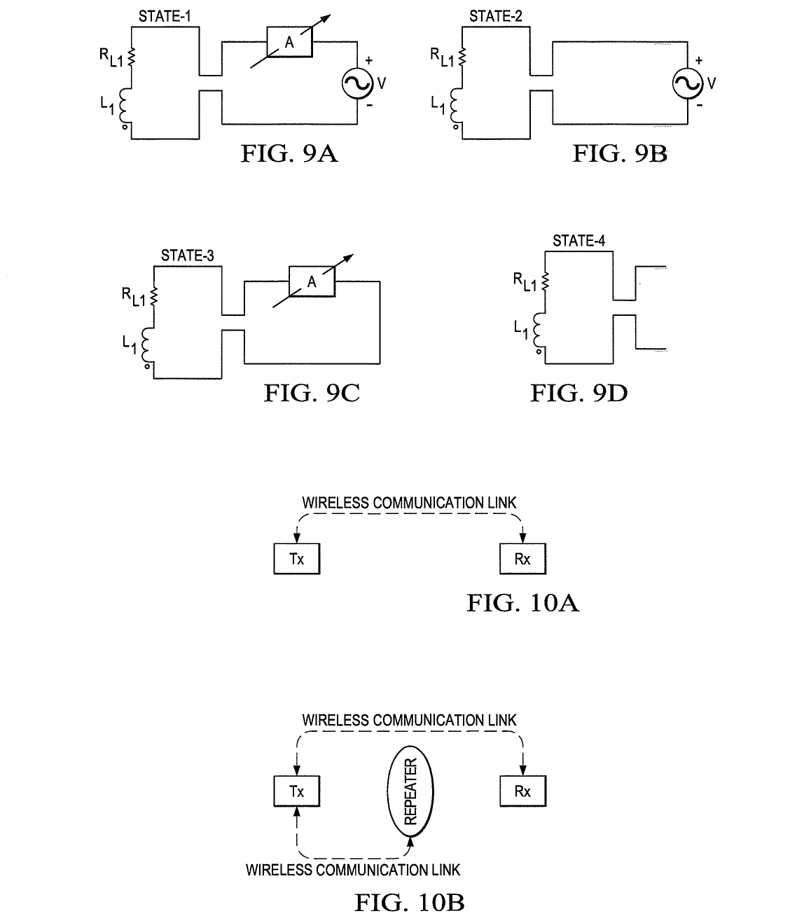

In operation 815, the self-impedances of each device in the network are measured. To perform this measurement each device is required to switch between two states: State-1 and State-4. Specifically, the coordinating transmitter requests sequentially each device to apply a voltage across its terminals and measure the corresponding complex current in State-1 as illustrated in FIG. 9A. As one after the other each device goes into State-1, all the other devices are signaled to disconnect their loads from the inductive resonators in State-4 as illustrated in FIG. 9D, for example, using a switch, to go into open-circuit state. Through the State-1, the devices measure the current corresponding to the applied voltage.

In operation 820, the devices transmit information regarding the self-impedance. In certain embodiments, each device transmits an applied voltage and a measured current, or a self-impedance value to the coordinating transmitter via the wireless communication link. The coordinating transmitter collects information regarding the self-impedance, zᵢᵢ (i=1 . . . M, M≦N) of each device, and from that can extract information such as an inductance, a loss resistance or a quality factor of each device in the wireless power transfer network, which constitute diagonal elements of Z-matrix.

In certain embodiments, the switching of each device between State-1 and State-4 can happen with either separate sequential signals transmitted from the coordinating transmitter, such that the signal 10000 . . . 0 would mean that the device corresponding to “1” enters into State-1 while the other receivers corresponding to “0” enter to State-4. Alternatively, transmitter can send a single signal to the receivers so that the receivers perform the measurement in State-1 in their own time offset with respect to the signal, and then switch to State-4.

In operation 825, the process determines the mutual-impedances, zᵢⱼ (i,j=1 . . . M, i≠j, M≦N) of the devices in the network, which constitute the off-diagonal elements of the Z-matrix. To do this, each device has to switch among 3 states as shown in FIGS. 9A to 9D. Specifically, the coordinating transmitter can signal separately each device to switch to a certain state, or as described above, a single signal with respective time offset assigned to each device to follow a prescribed switching between states.

For example, to measure mutual impedance, z₁₂, and hence coupling coefficient, κ₁₂, between pairing devices 1 and 2, device 1 is signaled to switch to State-2, where device 1 applies a voltage to inductor's terminals as illustrated in FIG. 9B. At the same time device 2 is switched to State-3, where device 2 measures the current induced at its inductor's terminals as illustrated in FIG. 9C. Concurrently all other devices in the wireless power transfer network are signaled to switch to State-4. Devices 1 and 2 transmit the corresponding voltage and current measurement to the coordinating transmitter via a wireless communication link. In this way, the coordinating transmitter collects information regarding mutual impedances between all device pairs in the network (in case of reciprocal networks where zᵢⱼ=zⱼᵢ, mutual impedance between unique device pairs is only measured. In other words, for the reciprocal wireless power transfer networks, zᵢⱼ=zⱼᵢ, so it is sufficient to only measure the elements above (or below) the main diagonal of the Z-matrix. Thus we can make Step-2 faster by changing this requirement to j>i).

After the each pair's mutual-impedance measurement, the two devices send the respective applied voltage and measured induced current to the coordinating transmitter in operation 830. The coordinating transmitter calculates the mutual impedance between all device pairs and extracts other information such as the coupling coefficients and mutual impedances between all pairs of devices. In certain embodiment where the coordinating transmitter is in a pair, the other device in the pair can transmit a measured induced current or its mutual impedance since the coordinating transmitter already knows the applied voltage.

In operation 840, based on the collected information the coordinating transmitter calculates the required optimum impedances for each device in the network using analytical formulas such as Equation 28 and provides feedback through the wireless communication link to the devices to adjust their impedance via matching networks to yield a certain optimal power transfer efficiency (such as maximum total efficiency). The coordinating transmitter, as part of the wireless network, also adjusts its own impedance following the above procedure, so that it is optimally matched.

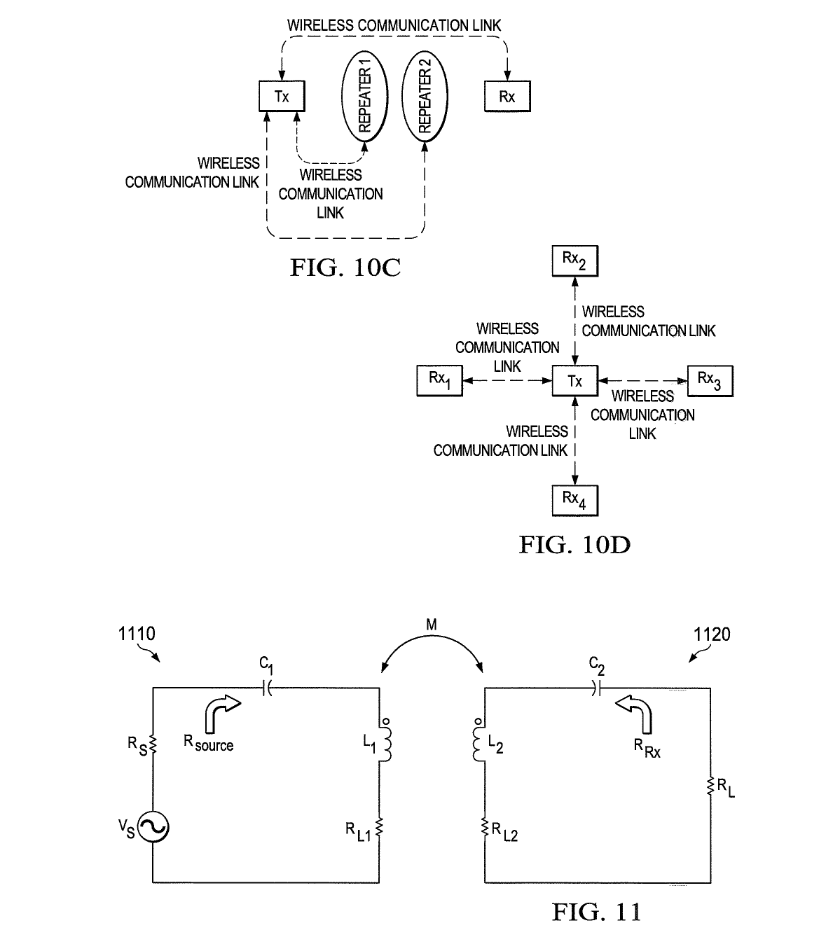

FIGS. 10A, 10B, 10C and 10D illustrate wireless communication links established in the various wireless power transfer networks according to embodiments of the present disclosure. The embodiments of the wireless power transfer networks shown in FIGS. 10A, 10B, 10C and 10D are for illustration only. Other embodiments of wireless power transfer network could be used without departing from the scope of the present disclosure.

Tuning algorithm requires a wireless communication link between the devices for handshaking setup to adjust source and load impedances to achieve optimal coupling efficiency. With the wireless communication links, the transmitter measures essentially the Z-matrix (or S-matrix computed from Z-matrix) of the wireless power transfer network, which contains information about the loss resistances, inductances and quality factors of the inductive resonators of all devices in the wireless power transfer network, as well as the coupling coefficients between all device pairs. The coordinating transmitter generates the appropriate timed signaling to each device and also records the measurements and performs the calculations to find optimized impedance conditions. After that, the aforementioned measurement data can be post-processed using the impedance formulas provided below (e.g., Equation 29) and be used to adjust the matching network of each device to the optimized impedance to achieve a certain required power transfer efficiency such as maximum total efficiency at the devices.

As illustrated in FIG. 10A, the network can include a single transmitter Tx and a single receiver Rx with no repeater, where the transmitter Tx is wirelessly linked to the receiver Rx via, for example, ZIG-BEE, infrared, BLUETOOTH, or any suitable near or far field communication links. FIG. 10B illustrates a transmitter Tx and a receiver Rx with a repeater between them, where the transmitter Tx can be wirelessly linked to the repeater and the receiver Rx respectively. FIG. 10C illustrates a transmitter Tx and a receiver Rx with two repeaters, repeater 1 and repeater 2 where the transmitter Tx can be wirelessly linked to the repeater 1 and the receiver 2 respectively. FIG. 10D illustrates a transmitter Tx and multiple receivers, receivers Rx₁ to Rx₄, where the transmitter is wirelessly linked to receivers Rx₁ to Rx₄.

FIG. 11 illustrates the wireless power transmission network including a transmitter 1110 and a receiver 1120 with no repeater according to embodiments of the present disclosure. The embodiment of the wireless power transmission network shown in FIG. 11 is for illustration only. Other embodiments of wireless power transfer network could be used without departing from the scope of the present disclosure.

Typically, small inductive resonators can be modeled as series RL circuits. It is noted that this model is accurate only for substantially small resonator sizes (i.e., when maximum dimension of antenna is substantially small compared to the wavelength at the frequency of operation). Hereinafter, the derivation of maximum efficiency limit will be presented based on the equivalent circuit approach for a single transmitter and receiver with no repeater. This model does not include higher order radiated spherical modes as antenna size increases.

With reference to FIG. 11, L₁, R_{L1} are the inductance and resistance of source inductive resonator respectively, and L₂, R_{L2} are the inductance and resistance of load inductive resonator respectively. Capacitors C₁ and C₂ are added to resonate transmitter and receiver at same resonant frequency ωₒ=1\sqrt{L₁C₁}=1/\sqrt{L₂C₂} for maximum power transfer. Rₛ and R_{L} are the source and load resistance, respectively.

Coordinating transmitter 1110 establishes a communication link with the receiver in the wireless power transfer network via ZIG-BEE, infrared, BLUETOOTH or near or far field communication (NFC) link.

Coordinating transmitter 1110 signals receiver 1120 to go into State-1. At the same time, coordinating transmitter goes into State-4 (and so would any other devices participating in the wireless charging network, except receiver 1120). Receiver 1120 applies a voltage to its inductive resonator's terminals and measures the corresponding current. Based on the applied voltage and measured current the self-impedance, z₂₂=R_{L2}jωL₂, of receiver 1120 can be calculated. Receiver 1120 transmits the applied voltage and measured current value to the coordinating transmitter 1110 via a wireless communication link. The coordinating transmitter 1110, receivers the information and can calculate the self-impedance of the inductive resonator of receiver 1120 and also extract information regarding, for example, the inductance and loss resistance, L₂, R_{L2} (and quality factor Qᵢₙₜ₂) of receiver's 1120 inductive resonator.

In this manner the coordinating transmitter collects information about the self-impedances and hence inductances and resistances of all inductive resonators (including its own), which constitute diagonal elements of Z-matrix.

To determine the mutual impedance z₁₂, constituting the off-diagonal elements of the Z-matrix of a wireless power transfer system, between the coordinating transmitter's inductive resonator and the receiver's 1120 inductive resonator and hence the mutual inductance M, the coordinating transmitter 1110 switches into State-2 and applies a voltage across its inductive resonator's terminals and at the same time signals receiver 1120 to switch to State-3, where receiver 1120 measures the current induced at its inductive resonator's terminals. At the same time, all other devices participating in the wireless charging network are signaled to go into State-4. At the end of this measurement, the receiver 1120 transmits via a wireless communication link, to the coordinating transmitter, the value of the measured current. Based on the respective applied voltage and induced current, the coordinating transmitter calculates the mutual impedance between the coordinating transmitter 1110 and receiver 1120 and extracts information regarding a mutual inductance M and a coupling coefficient, κ, between the two devices. In certain embodiments, receiver 1120 determines and provides a mutual impedance to the transmitter 1110. Alternatively, transmitter 1110 can calculate the mutual impedance between two devices based on the measurement at receiver 1120.

In the following embodiments, we show the analysis and deduce the analytical formulas that are used to determine the optimum impedance conditions for the devices in a wireless power transfer network. The following formulas are derived for certain wireless power transfer networks and should not limit the scope of this invention to only those specific networks.

Based on collected information through the above operations, in the case of a two-devices network comprised of a coordinating transmitter (source) and a receiver (load), the resonant coupling efficiency of η, input impedance at source of R_{source} and output impedance at load of R_{Rx} are derived by:

$$\begin{matrix}\begin{matrix}η = \frac{{P}_{r}}{{P}_{t}} \\ = \frac{4 {( ω M )}^{2} {R}_{s} {R}_{L}}{{[ ( {R}_{s} + {R}_{L 1} ) ( {R}_{L} + {R}_{L 2} ) + {( ω M )}^{2} ]}^{2}}\end{matrix} & ( 2 ) \\ {R}_{source} = {R}_{L 1} + \frac{{( ω M )}^{2}}{{R}_{L} + {R}_{L 2}} & ( 3 ) \\ {R}_{Rx} = {R}_{L 2} + \frac{{( ω M )}^{2}}{{R}_{s} + {R}_{L 1}} & ( 4 )\end{matrix}$$

The efficiency Equation 2 is differentiated with respect to the source resistance of Rₛ and the load resistance of R_{L}, and the derivatives are set to zero to obtain source and load resistance values that yield maximum efficiency. Then, Rₛ and R_{L} are given by:

$$\begin{matrix}{R}_{S} = {R}_{L 1} + \frac{{( ω M )}^{2}}{( {R}_{L} + {R}_{L 2} )} & ( 5 ) \\ {R}_{L} = {R}_{L 2} + \frac{{( ω M )}^{2}}{( {R}_{s} + {R}_{L 1} )} & ( 6 )\end{matrix}$$

Equations 5 and 6 show that source and load resistances which yield optimal efficiency are same as the input impedance and the output impedance seen by source and load respectively. These equations are solved simultaneously to express source and load resistances as a function of source resistance of R_{L1} and inductive resonator resistance of R_{L2} only, which are given by:

$$\begin{matrix}{R}_{S} = {R}_{L 1} \sqrt{1 + \frac{{ω}^{2} {M}^{2}}{{R}_{L 1} {R}_{L 2}}} & ( 7 ) \\ {R}_{L} = {R}_{L 2} \sqrt{1 + \frac{{ω}^{2} {M}^{2}}{{R}_{L 1} {R}_{L 2}}} & ( 8 )\end{matrix}$$

For inductive resonators with different inductive resonator resistances, the ratio of source and load resistances of R_{S}/R_{L} should be same as the ratio of respective inductive resonator resistances of R_{L1}/R_{L2}, which is given by:

$$\frac{{R}_{S}}{{R}_{L}} = \frac{{R}_{L 1}}{{R}_{L 2}} \qquad ( 9 )$$

Furthermore, in order to provide optimal efficiency for a wireless power transfer network consisting of single transmitter and receiver, the ratios of source resistance to source inductive resonator resistance of Rₛ/R_{L1} and load to load inductive resonator resistance of R_{L}/R_{L2} follow the following criteria:

$$\begin{matrix}\frac{{R}_{S}}{{R}_{L 1}} = \frac{{R}_{L }}{{R}_{L 2}} \\ = \sqrt{1 + \frac{{ω}^{2} {M}^{2}}{{R}_{L 1} {R}_{L 2}}} \\ = \sqrt{1 + {k}^{2} {Q}_{1 int} {Q}_{2 int}}\end{matrix} \\ where \\ {Q}_{1 int} = \frac{ω {L}_{1}}{{R}_{L 1}} , \\ {Q}_{2 int} = \frac{ω {L}_{2}}{{R}_{L 2}} , \\ and \\ k = \frac{ω M}{\sqrt{{L}_{1} {L}_{2}}} \qquad ( 10 )$$

The corresponding optimum efficiency under simultaneous impedance match at the source and the load is then:

$${η}_{opt} = \frac{1}{{[ \sqrt{( 1 + \frac{1}{{k}^{2} {Q}_{1 int} {Q}_{2 int}} )} + \frac{1}{k \sqrt{{Q}_{1 int} {Q}_{2 int}}} ]}^{2}} \qquad ( 11 )$$

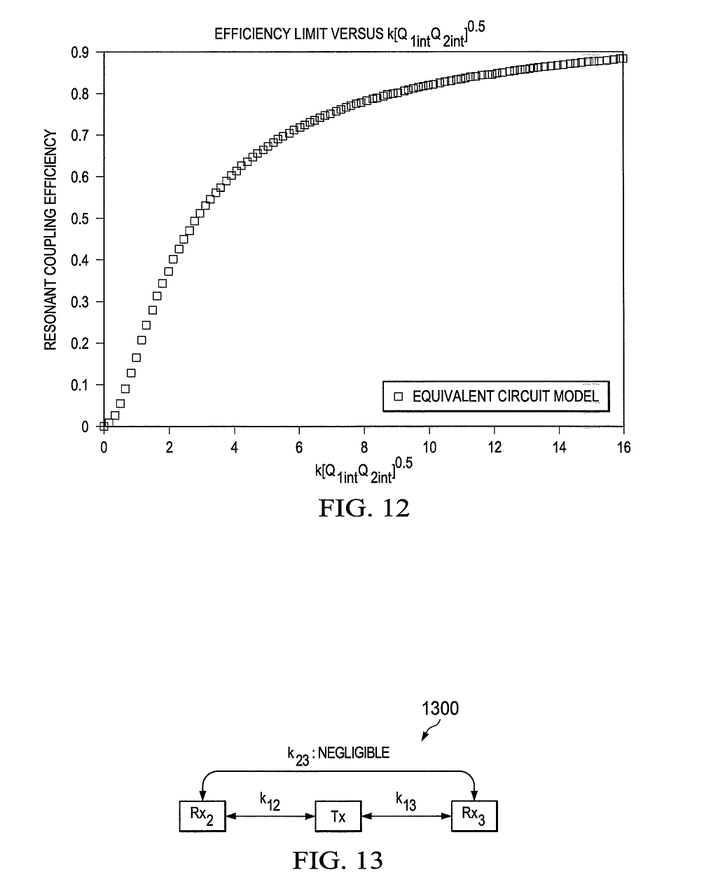

The optimal efficiency expression based on equivalent circuit model is plotted in FIG. 12. It is observed that upper bound on efficiency derived based on coupled mode theory is same as that derived using equivalent circuit model. For a certain coupling between inductive resonators with a given quality factor, this curve sets the limit on maximum achievable efficiency.

FIG. 12 plots optimal efficiency versus k\sqrt{Q₁ᵢₙₜQ₂ᵢₙₜ}, which is equal to ωM/\sqrt{R_{L1}R_{L2}}. As illustrated, the higher the value of ωM/\sqrt{R_{L1}R_{L2}}, the higher is efficiency. This is why inductive resonators used in wireless power transfer are preferred to have very small loss resistance. Therefore, the equivalent series resistance (ESR) of the capacitors used to resonate the system, or any additional resistances introduced due to interconnecting wires and solder will lower the system efficiency.

Efficiency is degraded more when the system is operating at lower ωM/\sqrt{R_{L1}R_{L2}} values. As an example, assume that inductive resonators are designed such that ωM/\sqrt{R_{L1}R_{L2}}=4; then looking at FIG. 12 the maximum efficiency is expected to be 60%.

However, if ESR of capacitor, possible interconnects or soldering on both transmitter and receiver, adds resistance equal to the inductive resonator resistance, then the value of ωM/\sqrt{R_{L1}R_{L2}} drops from 4 to 2, and the corresponding efficiency drops from 60% to 40%.

Once the efficiency is determined, the transmitter calculates the required impedance using analytical formulas such as Equation 10 and provides a feedback to the receiver to adjust the impedance via the matching networks at all the loads to yield optimal coupling efficiency. Finally, the transmitter adjusts its impedance following the above procedure, so that the transmitter is optimally matched to accomplish the determined power transmission efficiency.

FIG. 13 illustrates the wireless power transmission network 1300 including a coordinating transmitter Tx and two non-coupled receivers (k₁₂²Q₁Q₂<<1 where k₁₂ is the coupling coefficient between the two receivers and Q₁, Q₂ are their quality factors), Rx₂ and Rx₃, according to certain embodiment of the present disclosure. The embodiment of the wireless power transmission network shown in FIG. 13 is for illustration only. Other embodiments of wireless power transfer network could be used without departing from the scope of the present disclosure.

The efficiency limit is now evaluated for a wireless power transfer network including two receivers. Both the receivers are coupled to the coordinating transmitter; however for simplicity, coupling between receivers is assumed to be negligibly small. This is the case when there is a large transmitter and small receivers or small receivers on opposite side of the transmitter, as shown in FIG. 13.

After establishing a communication link with the receivers in the wireless power transfer network, the coordinating transmitter Tx requests sequentially each receiver, Rx₂ and Rx₃, to apply a voltage across its terminals and measure the corresponding current. As one after the other receiver goes into State-1, the other receiver and coordinating transmitter go to State-4 and the coordinating transmitter Tx collects information about an inductance and a resistance of inductive resonator of two receivers, Rx₂ and Rx₃, which constitute diagonal elements of Z-matrix.

Consequently, the network determines the mutual impedance between the transmitter Tx and two receivers, Rx₂ and Rx₃, which constitute the off-diagonal elements of the Z-matrix. The specific tuning algorithm in the embodiment is similar to what discussed above and repeated description is omitted.

Through the above measuring operations, the wireless power transfer network consisting of the transmitter Tx and two non-coupled receivers, Rx₂ and Rx₃, is represented in the matrix form as follows:

$$[ \begin{matrix}{R}_{S} + {R}_{L 1} & jω {M}_{12} & jω {M}_{13} \\ jω {M}_{12} & {R}_{2} + {R}_{L 2} & 0 \\ jω {M}_{13} & 0 & {R}_{3} + {R}_{L 3}\end{matrix} ] [ \begin{matrix}{i}_{1} \\ {i}_{2} \\ {i}_{3}\end{matrix} ] = [ \begin{matrix}{v}_{s} \\ 0 \\ 0\end{matrix} ] \qquad ( 12 )$$

where, R_{S}, R₂, R₃ are source and load resistances, R_{L1}, R_{L2}, R_{L3} are source and load inductive resonator resistances, M₁₂ and M₁₃ are mutual inductances between source inductive resonator and first receiver inductive resonator, and second receiver inductive resonator, respectively. The current through the transmitter and two receivers is i₁, i₂ and i₃ respectively. The input impedances seen by transmitter and receivers are respectively as follows:

$$\begin{matrix}{R}_{source} = ( {R}_{L 1} ) + \frac{{( ω {M}_{12} )}^{2}}{( {R}_{L 2} + {R}_{2} )} + \frac{{( ω {M}_{13} )}^{2}}{( {R}_{L 3} + {R}_{3} )} & ( 13 ) \\ {R}_{Rx2} = ( {R}_{L 2} ) + \frac{{( ω {M}_{12} )}^{2}}{( {R}_{L 1} + {R}_{s} ) + \frac{{( ω {M}_{13} )}^{2}}{( {R}_{L 3} + {R}_{3} )}} & ( 14 ) \\ {R}_{Rx 3} = ( {R}_{L 3} ) + \frac{{( ω {M}_{13} )}^{2}}{( {R}_{L 1} + {R}_{s} ) + \frac{{( ω {M}_{12} )}^{2}}{( {R}_{L 2} + {R}_{2} )}} & ( 15 )\end{matrix}$$

In certain embodiments, a source impedance is matched to the input impedance to minimize reflections to the source and then the load impedances which lead to optimal efficiency under the impedance matched source assumption are calculated. Because the power levels at the transmitter are multiple times those at the receiver, any mismatch at the source side will lead to excessive heat generation. Alternatively, a mismatched receiver will not receive power. Alternatively, certain embodiments simultaneously match the transmitter and both receivers.

The respective efficiencies η₂₁, η₃₁ for the receivers Rx₂ and Rx₃ using matrix model in Equation 12 are as follows:

$$\begin{matrix}{η}_{21} = \frac{4 {( ω {M}_{12} )}^{2} {R}_{s} {R}_{2}}{{[ ( {R}_{s} + {R}_{L 1} ) ( {R}_{2} + {R}_{L 2} ) + {( ω {M}_{12} )}^{2} + \frac{( {R}_{2} + {R}_{L 2} ) {( ω {M}_{13} )}^{2}}{( {R}_{3} + {R}_{L 3} )} ]}^{2}} & ( 16 ) \\ {η}_{31} = \frac{4 {( ω {M}_{13} )}^{2} {R}_{s} {R}_{3}}{{[ ( {R}_{s} + {R}_{L 1} ) ( {R}_{3} + {R}_{L 3} ) + {( ω {M}_{13} )}^{2} + \frac{( {R}_{3} + {R}_{L 3} ) {( ω {M}_{12} )}^{2}}{( {R}_{2} + {R}_{L 2} )} ]}^{2}} & ( 17 )\end{matrix}$$

Matching the source resistance R_{S} to the input impedance seen at the source port R_{source}, the efficiency expressions given by Equations 16 and 17 can be written as:

$$\begin{matrix}{η}_{21} = \frac{α}{α + 1} ( \frac{1}{1 + \frac{α + 1}{{k}_{12}^{2} {Q}_{1 int} {Q}_{2 int}} + ( \frac{α + 1}{β + 1} ) ( \frac{{k}_{13}^{2} {Q}_{1 int} {Q}_{3 int}}{{k}_{12}^{2} {Q}_{1 int} {Q}_{2 int}} )} ) & ( 18 ) \\ {η}_{31} = \frac{β}{β + 1} ( \frac{1}{1 + \frac{β + 1}{{k}_{13}^{2} {Q}_{1 int} {Q}_{3 int}} + ( \frac{β + 1}{α + 1} ) ( \frac{{k}_{12}^{2} {Q}_{1 int} {Q}_{2 int}}{{k}_{13}^{2} {Q}_{1 int} {Q}_{3 int}} )} ) \\ where \\ α = \frac{{R}_{2}}{{R}_{L 2}} , \\ β = \frac{{R}_{3}}{{R}_{L 3}} \\ and \\ {Q}_{1 int} = \frac{ω {L}_{1}}{{R}_{L 1}} , \\ {Q}_{2 int} = \frac{ω {L}_{2}}{{R}_{L 2}} , \\ {Q}_{3 int} = \frac{ω {L}_{3}}{{R}_{L 3}} . & ( 19 )\end{matrix}$$

The total efficiency is obtained by adding the efficiencies η₂₁, η₃₁ at Rx₂ and Rx₃ as follows:

ηₜₒₜₐₗ=η₂₁+η₃₁ (20)

In certain embodiments, weighting/cost function value can be multiplied to each the receiver according to the priorities of charging. In certain embodiment, a receiver with a need of urgent charging has a higher priority than other receivers in the network.

Total efficiency expression given by Equation 20 is differentiated with respect to α and β and derivative is set to zero. Two equations are simultaneously solved and values of α and β which yield optimal efficiency performance are as follows:

α_{best}=β_{best}=\sqrt{1+k₁₂²Q₁ᵢₙₜQ₂ᵢₙₜ+k₁₃²Q₁ᵢₙₜQ₃ᵢₙₜ} (21)

Substituting α and β for optimal efficiency performance into Equation 13, the ratio of source resistance to source inductive resonator resistance of R_{S}/R_{L1}, and the ratios of load resistance to load inductive resonator resistance of R₂/R_{L2} and R₃/R_{L3} are equal to the value specified as follows:

$$\begin{matrix}\frac{{R}_{S}}{{R}_{L 1}} = \frac{{R}_{2}}{{R}_{L 2}} \\ = \frac{{R}_{3}}{{R}_{L 3}} \\ = \sqrt{1 + {k}_{12}^{2} {Q}_{1 int} {Q}_{2 int} + {k}_{13}^{2} {Q}_{1 int} {Q}_{3 int}}\end{matrix} \qquad ( 22 )$$

Hence optimal efficiency is obtained when the ratio of source resistance to source inductive resonator resistance, the ratio of load resistances to their respective inductive resonator resistances, is same and equal to the value specified in Equation 22 which is consistent with the observation for a wireless power transfer network consisting of a single transmitter and receiver.

The corresponding efficiency at two receivers are:

$$\begin{matrix}{η}_{21} = \frac{\sqrt{\begin{matrix}1 + {k}_{12}^{2} {Q}_{1 int} {Q}_{2 int} + \\ {k}_{13}^{2} {Q}_{1 int} {Q}_{3 int}\end{matrix}}}{\sqrt{\begin{matrix}1 + {k}_{12}^{2} {Q}_{1 int} {Q}_{2 int} + \\ {k}_{13}^{2} {Q}_{1 int} {Q}_{3 int}\end{matrix}} + 1} \times \frac{1}{1 + \frac{\sqrt{\begin{matrix}1 + {k}_{12}^{2} {Q}_{1 int} {Q}_{2 int} + \\ {k}_{13}^{2} {Q}_{1 int} {Q}_{3 int}\end{matrix}} + 1}{{k}_{12}^{2} {Q}_{1 int} {Q}_{2 int}} + ( \frac{{k}_{13}^{2} {Q}_{1 int} {Q}_{3 int}}{{k}_{12}^{2} {Q}_{1 int} {Q}_{2 int}} )} \\ & ( 23 ) \\ {η}_{31} = \frac{\sqrt{\begin{matrix}1 + {k}_{12}^{2} {Q}_{1 int} {Q}_{2 int} + \\ {k}_{13}^{2} {Q}_{1 int} {Q}_{3 int}\end{matrix}}}{\sqrt{\begin{matrix}1 + {k}_{12}^{2} {Q}_{1 int} {Q}_{2 int} + \\ {k}_{13}^{2} {Q}_{1 int} {Q}_{3 int}\end{matrix}} + 1} \times \frac{1}{1 + \frac{\sqrt{\begin{matrix}1 + {k}_{12}^{2} {Q}_{1 int} {Q}_{2 int} + \\ {k}_{13}^{2} {Q}_{1 int} {Q}_{3 int}\end{matrix}} + 1}{{k}_{13}^{2} {Q}_{1 int} {Q}_{3 int}} + ( \frac{{k}_{12}^{2} {Q}_{1 int} {Q}_{2 int}}{{k}_{13}^{2} {Q}_{1 int} {Q}_{3 int}} )} & ( 24 )\end{matrix}$$

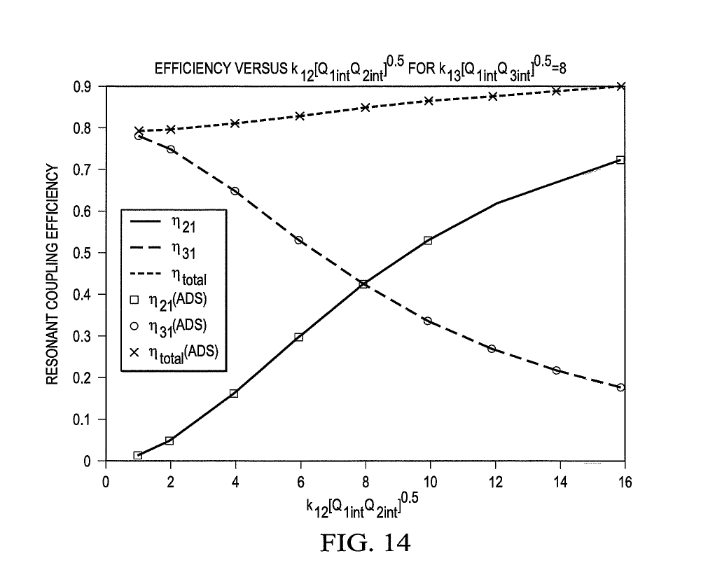

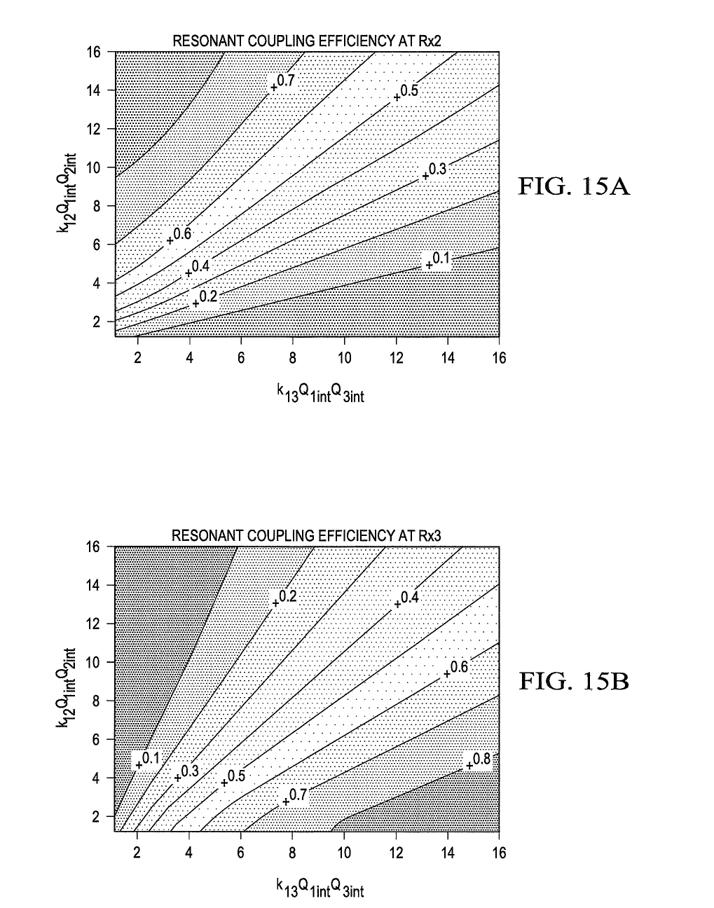

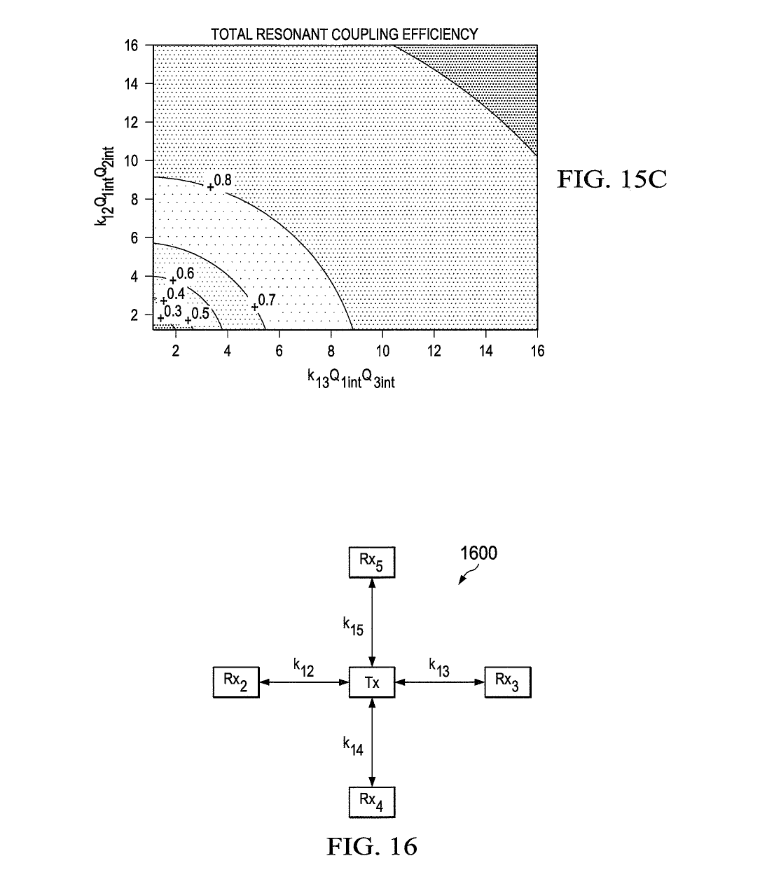

In order to validate the results, efficiency at Rx₂ and Rx₃, and total efficiency given by Equation 23, 24 and 20 respectively are plotted under optimal source and load conditions given by Equation 22, for a fixed coupling between transmitter Tx and receiver Rx₃ in FIG. 14. The couplings between transmitter Tx and receivers Rx₂ and Rx₃ can vary. The efficiencies are also calculated from equivalent circuit model in Advanced Design System (ADS) software and the results exactly correspond to each other. It is observed that if one of the receivers is coupled much strongly to the transmitter compared to the other receiver, then almost all the power goes to the strongly coupled receiver. When both receivers are equally coupled to the transmitter, then they share the received power equally. The efficiency contours for efficiency at receivers Rx₂, Rx₃ and total efficiency of the network are plotted in FIGS. 15A to 15C respectively.

FIG. 16 illustrates the wireless power transmission network 1600 comprising a single transmitter Tx and multiple non-coupled receivers, Rx2 to Rx 5, according to certain embodiment of the present disclosure. The embodiment of the wireless power transmission network shown in FIG. 16 is for illustration only. Other embodiments of wireless power transfer network could be used without departing from the scope of the present disclosure.

The efficiency analysis can be extended to multiple receivers, which are coupled directly to the transmitter and their mutual couplings are ignored. Such a wireless power transfer network consisting of single transmitter and (n−1) non-coupled receivers is shown in FIG. 16.

The coordinating transmitter Tx establishes a communication link with the four receivers, Rx₂ to Rx₅, in the wireless power transfer network and collects information regarding self-impedances of the receivers in the network are measured. Specifically, the transmitter Tx requests sequentially each receiver to apply a voltage across its terminals and measure the corresponding current. As one after the other, each receiver goes into State-1, all other receivers can be signaled to disconnect their loads from the inductive resonators, for example, using a switch, i.e. go into State-4.

Consequently, the transmitter collects information regarding the mutual impedances in the network, which constitute the off-diagonal elements of the Z-matrix. Specifically, the transmitter Tx can signal separately each receiver to indicate its state, or as described above a single signal with a corresponding sequence number and a time slot assigned to each device to follow a prescribed switching between states.

The input impedances seen by the transmitter Tx and the receivers Rx₂ to Rx₅ are as follows:

$$\begin{matrix} {R}_{source} = {R}_{L 1} + \frac{{( ω {M}_{12} )}^{2}}{( {R}_{L 2} + {R}_{2} )} + \frac{{( ω {M}_{13} )}^{2}}{( {R}_{L 3} + {R}_{3} )} + … + \frac{{( ω {M}_{1 n} )}^{2}}{( {R}_{L 3} + {R}_{n} )} & ( 25 ) \\ {R}_{Rx 2} = {R}_{L 2} + \frac{{( ω {M}_{12} )}^{2}}{( {R}_{L 1} + {R}_{s} ) + \frac{{( ω {M}_{13} )}^{2}}{( {R}_{L 3} + {R}_{3} )} + \frac{{( ω {M}_{14} )}^{2}}{( {R}_{L 4} + {R}_{4} )} + … + \frac{{( ω {M}_{1 n} )}^{2}}{( {R}_{L n} + {R}_{n} )}} & ( 26 ) \\ {R}_{Rx 3} = {R}_{L 3} + \frac{{( ω {M}_{13} )}^{2}}{( {R}_{L 1} + {R}_{s} ) + \frac{{( ω {M}_{12} )}^{2}}{( {R}_{L2} + {R}_{2} )} + \frac{{( ω {M}_{14} )}^{2}}{( {R}_{L 4} + {R}_{4} )} + … + \frac{{( ω {M}_{1 n} )}^{2}}{( {R}_{L n} + {R}_{n} )}} \\ ⋮ & ( 27 ) \\ {R}_{Rx n} = {R}_{L n} + \frac{{( ω {M}_{1 n} )}^{2}}{\begin{matrix}( {R}_{L 1} + {R}_{s} ) + \frac{{( ω {M}_{12} )}^{2}}{( {R}_{L 2} + {R}_{2} )} + \\ \frac{{( ω {M}_{13} )}^{2}}{( {R}_{L 3} + {R}_{3} )} + … + \frac{{( ω {M}_{1 ( n - 1 )} )}^{2}}{( {R}_{L ( n - 1 )} + {R}_{( n - 1 )} )}\end{matrix}} & ( 28 )\end{matrix}$$

The optimal efficiency is obtained when the ratios of source resistance to source inductive resonator resistance of Rₛ/R_{L1} and load to load inductive resonator resistance of Rₙ/R_{Ln} follow the following criteria:

$$\frac{{R}_{S}}{{R}_{L 1}} = \frac{{R}_{2}}{{R}_{L 2}} = \frac{{R}_{3}}{{R}_{L 3}} = … = \frac{{R}_{n}}{{R}_{L n}} = γ = \sqrt{1 + {k}_{12}^{2} {Q}_{1 int} {Q}_{2 int} + {k}_{13}^{2} {Q}_{1 int} {Q}_{3 int} + … + {k}_{1 n}^{2} {Q}_{1 int} {Q}_{n int}} \\ where {Q}_{1 int} = \frac{ω {L}_{1}}{{R}_{L 1}} , {Q}_{n int} = \frac{ω {L}_{n}}{{R}_{L n}} , and {k}_{1 n} = \frac{ω M i n}{\sqrt{{L}_{1} {L}_{n}}} . \qquad ( 29 )$$

The ratio of source resistance to source inductive resonator resistance should be equal to the ratio of load resistances to corresponding load inductive resonator resistances.

The efficiency expressions for each receiver under optimal efficiency conditions at source and loads are as follows:

$$\begin{matrix}{η}_{21} = \frac{γ}{γ + 1} ( \frac{1}{\frac{γ + 1}{{k}_{12}^{2} {Q}_{1 int} {Q}_{2 int}} + ( \frac{{k}_{12}^{2} {Q}_{1 int} {Q}_{2 int}}{{k}_{12}^{2} {Q}_{1 int} {Q}_{2 int}} ) + … + ( \frac{{k}_{1 n}^{2} {Q}_{1 int} {Q}_{n int}}{{k}_{12}^{2} {Q}_{1 int} {Q}_{2 int}} )} ) & ( 30 ) \\ {η}_{31} = \frac{γ}{γ + 1} ( \frac{1}{\frac{γ + 1}{{k}_{13}^{2} {Q}_{1 int} {Q}_{3 int}} + ( \frac{{k}_{12}^{2} {Q}_{1 int} {Q}_{3 int}}{{k}_{13}^{2} {Q}_{1 int} {Q}_{3 int}} ) + … + ( \frac{{k}_{1 n}^{2} {Q}_{1 int} {Q}_{n int}}{{k}_{13}^{2} {Q}_{1 int} {Q}_{3 int}} )} ) & ( 31 ) \\ {η}_{n 1} = \frac{γ}{γ + 1} ( \frac{1}{\frac{γ + 1}{{k}_{1 n}^{2} {Q}_{1 int} {Q}_{nint}} + ( \frac{{k}_{12}^{2} {Q}_{1 int} {Q}_{3 int}}{{k}_{1 n}^{2} {Q}_{1 int} {Q}_{nint}} ) + … + ( \frac{{k}_{1 n}^{2} {Q}_{1 int} {Q}_{n int}}{{k}_{1 n}^{2} {Q}_{1 int} {Q}_{n int}} )} ) & ( 32 )\end{matrix}$$

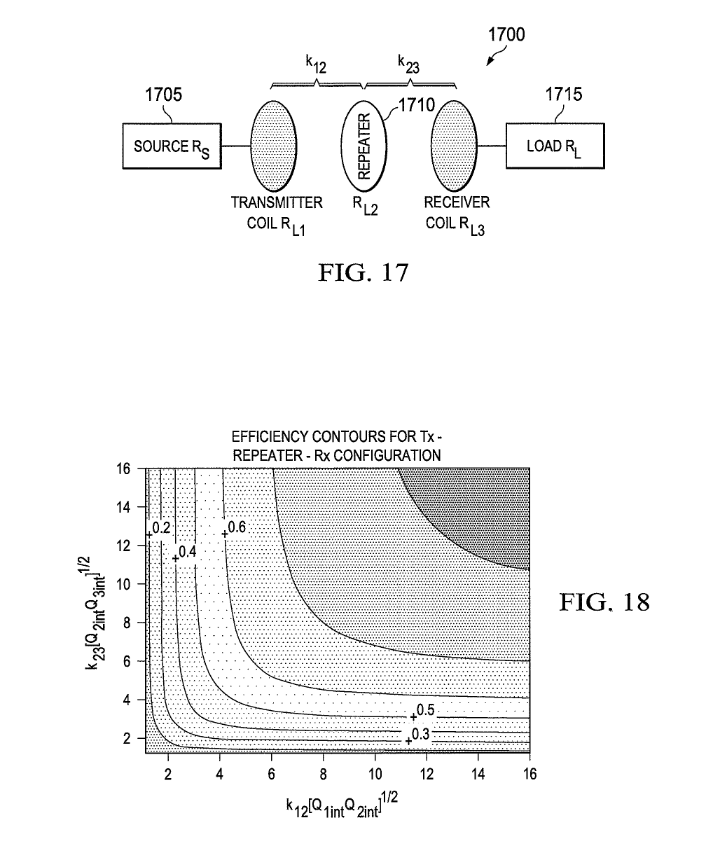

FIG. 17 illustrates a wireless power transmission network 1700 comprising a transmitter 1705, a receiver 1715 and a repeater 1710 between transmitter 1705 and receiver 1715 according to embodiments of the present disclosure. The embodiment of the wireless power transmission network shown in FIG. 17 is for illustration only. Other embodiments of wireless power transfer network could be used without departing from the scope of the present disclosure. Repeater 1710 is used between transmitter and receiver to enhance the power transfer efficiency and the transmission distance from transmitter 1705 to receiver 1715.

It is observed that repeater 1710 should be only a inductive resonator resonant at the resonance frequency of transmitter 1705 and receiver 1710 with no external resistance attached to it, since any additional resistance increases the power loss at repeater 1710. The direct coupling between transmitter 1705 and receiver 1715 is neglected for simplicity.

Transmitter 1705 establishes a communication link with repeater 1710 and receiver 1715 and collects information regarding internal-impedances of repeater 1710 and receiver 1715 in the network. Specifically, transmitter 1705 requests sequentially repeater 1710 and receiver 1715 to apply a voltage across their terminals and measures the corresponding currents. (State-1). As one after the other, each device goes into State-1, all other devices can be signaled to disconnect their load from the inductive resonator, for example, using a switch, and go into State-4. In this manner the transmitter 1705 collects information about inductances, loss resistances (or inductive resonator resistances) and quality factors of repeater 1710 and receiver 1715 in the network, which constitutes diagonal elements of Z-matrix.

Based on the above collected information, a wireless power transfer network 1700 can be represented by the following matrix:

$$[ \begin{matrix}{R}_{s} + {R}_{L 1} & jω {M}_{12} & 0 \\ j ω {M}_{12} & {R}_{L 2} & jω {M}_{23} \\ 0 & j ω {M}_{23} & {R}_{3} + {R}_{L}\end{matrix} ] [ \begin{matrix}{i}_{1} \\ {i}_{2} \\ {i}_{3}\end{matrix} ] = [ \begin{matrix}{v}_{s} \\ 0 \\ 0\end{matrix} ] \qquad ( 33 )$$

The source is matched to the input impedance so that no power fed to the inductive resonator is reflected back to the transmitter.

$${R}_{S} = {R}_{input} = {R}_{L 1} + \frac{{( ω {M}_{12} )}^{2}}{{R}_{L 2} + \frac{{( ω {M}_{23} )}^{2}}{( {R}_{L 3} + {R}_{L} )}} \qquad ( 34 )$$

The receiver power transfer efficiency under the condition of impedance match at source is:

$$η = \frac{β ( {k}_{12}^{2} {Q}_{1 int} {Q}_{2 int} ) ( {k}_{23}^{2} {Q}_{2 int} {Q}_{3 int} )}{[ \begin{matrix}{( β + 1 )}^{2} ( 1 + {k}_{12}^{2} {Q}_{1 int} {Q}_{2 int} ) + ( β + 1 ) \\ ( \begin{matrix}2 {k}_{23}^{2} {Q}_{2 int} {Q}_{3 int} + \\ {k}_{12}^{2} {Q}_{1 int} {Q}_{2 int} {k}_{23}^{2} {Q}_{2 int} {Q}_{3 int}\end{matrix} ) + {( {k}_{23}^{2} {Q}_{2 int} {Q}_{3 int} )}^{2}\end{matrix} ]} \qquad ( 35 )$$

where, β is the ratio of load to loss resistance of the inductive resonator at receiver. In order to find optimum load which leads to the highest resonant coupling efficiency, above expression is differentiated with respect to β and the derivative is set to zero.

$$β = \sqrt{\frac{( 1 + {k}_{23}^{2} {Q}_{2 int} {Q}_{3 int} ) ( 1 + {k}_{12}^{2} {Q}_{1 int} {Q}_{2 int} + {k}_{23}^{2} {Q}_{2 int} {Q}_{3 int} )}{( 1 + {k}_{12}^{2} {Q}_{1 int} {Q}_{2 int} )}} \qquad ( 36 )$$

Efficiency contours for a wireless power transfer network consisting of a repeater between the transmitter Tx and the receiver Rx are plotted in FIG. 18, which give the efficiency for a given pair of coupling between transmitter-repeater and repeater-receiver. It is worthwhile to note here that the repeater does not need to be placed exactly between transmitter and receiver.

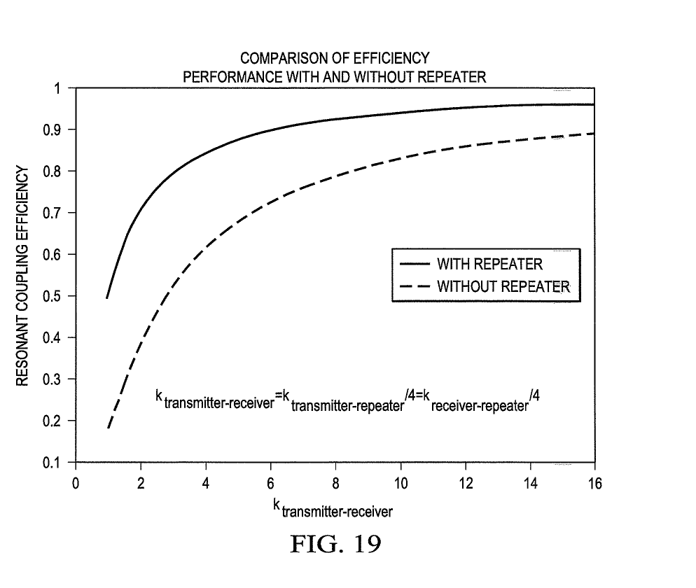

Another interesting comparison is to compare the performance with that of a case of single transmitter and receiver without a repeater, to the case where repeater is exactly between transmitter and receiver. The coupling between transmitter and receiver decreases with 1/R³ for distances much larger than the individual radii of inductive resonator. For distances comparable to the radius of the inductive resonators, the coupling coefficient decreases approximately with 1/R². The improvement in efficiency provided by a repeater over the case without a repeater is shown in FIG. 19.

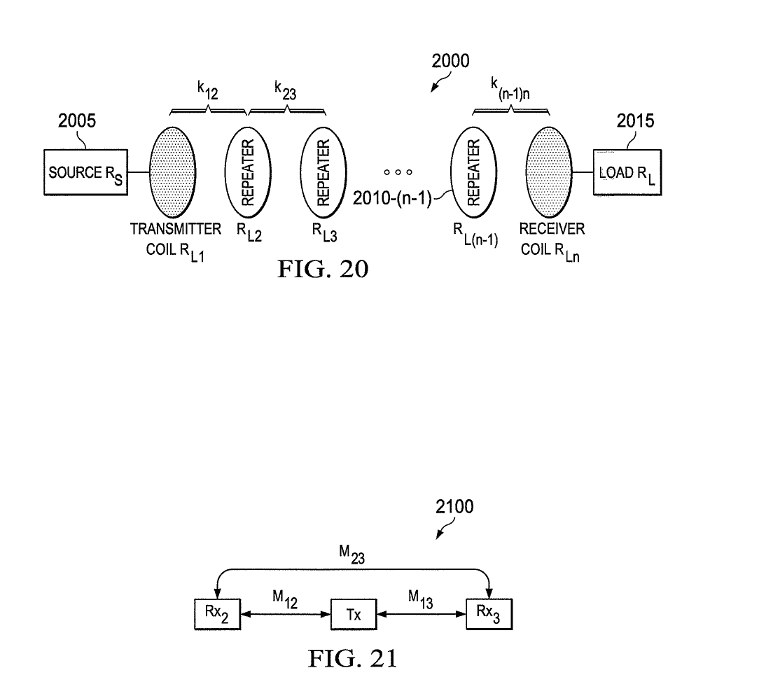

FIG. 20 illustrates a wireless power transmission network 2000 comprising a transmitter 2005, a receiver 2015 and multiple repeaters 2010-1 to 2010-(n−1) between transmitter 2005 and the receiver 2010 according to embodiments of the present disclosure. The embodiment of the wireless power transmission network shown in FIG. 20 is for illustration only. Other embodiments of wireless power transfer network could be used without departing from the scope of the present disclosure. Each repeater can include an inductive resonator resonant at the resonance frequency of the transmitter and the receiver. The inductive resonator resistance is the only source of loss at the repeaters.

The analysis in associated with the embodiment of the wireless power transmission network with a single repeater as illustrated FIG. 17 can be extended to a wireless power transmission network with multiple repeaters inserted between transmitter and receiver as shown in FIG. 20. The direct coupling between transmitter 2005 and receiver 2015, and non-adjacent repeaters are neglected for simplicity.

Transmitter 2005 establishes a communication link with repeaters 2010-1 to 2010-(n−1) and receiver 2015 and collects information regarding self-impedances of the repeaters and receiver in the network. Specifically, transmitter 2005 requests sequentially each repeater and receiver 2015 to apply a voltage to their terminals and measures the corresponding currents (State-1). As one after the other, each device goes into State-1, and all other devices can be signaled to disconnect their load from their inductive resonator, for example, using a switch (State-4). In this manner the transmitter 2005 collects information about inductive resonators self-impedances (inductances, loss resistances and quality factors) of repeaters 2010-1 to 2010-(n−1) and receiver 2015 in the network, which constitutes diagonal elements of Z-matrix. The detailed tuning algorithm for obtaining the mutual-impedances between all device pairs in the wireless power transfer network in the embodiment is similar to what discussed above and repeated description is omitted.

Based on the above collected information, the wireless power transfer network illustrated in FIG. 20 can be represented by the following matrix equation:

$$[ \begin{matrix}{R}_{s} + {R}_{L 1} & jω {M}_{12} & 0 & & 0 \\ jω {M}_{12} & {R}_{L 2} & jω {M}_{23} & … & 0 \\ 0 & j ω {M}_{23} & {R}_{L 3} & & 0 \\ & ⋮ & & ⋱ & ⋮ \\ 0 & 0 & 0 & … & {R}_{L} + {R}_{L n}\end{matrix} ] [ \begin{matrix}{i}_{1} \\ {i}_{2} \\ {i}_{3} \\ ⋮ \\ {i}_{n}\end{matrix} ] = [ \begin{matrix}{v}_{s} \\ 0 \\ 0 \\ ⋮ \\ 0\end{matrix} ] \qquad ( 37 )$$

The source is matched to the input impedance so that no power fed to the source inductive resonator is reflected back to the transmitter as follow:

$${R}_{S} = {R}_{input} = {R}_{L 1} + \frac{{( ω {M}_{12} )}^{2}}{{R}_{L 2} + \frac{{( ω {M}_{23} )}^{2}}{{R}_{L 3} + \frac{{( ω {M}_{34} )}^{2}}{{R}_{L 4} + \frac{{( ω {M}_{45} )}^{2}}{\begin{matrix}{R}_{L 5} + ⋱ \\ ⋮ \\ {R}_{L ( n - 1 )} + \frac{{( ω {M}_{( n - 1 ) n} )}^{2}}{{R}_{L n} + {R}_{L}}\end{matrix}}}}} \qquad ( 38 )$$

The receiver coupling efficiency under the condition of impedance match at source is:

$$η = \frac{β ( {l}_{12}^{2} ) ( {l}_{23}^{2} ) ( {l}_{34}^{2} ) … ( {l}_{( n - 1 ) n}^{2} )}{1 + \frac{{l}_{12}^{2}}{1 + \frac{{l}_{23}^{2}}{1 + \frac{{l}_{34}^{2}}{1 + \frac{{l}_{45}^{2}}{\begin{matrix}1 + ⋱ \\ ⋮ \\ 1 + \frac{{l}_{( n - 1 ) n}^{2}}{( β + 1 )}\end{matrix}}}}}} \times \frac{1}{{( 1 + \frac{{l}_{23}^{2}}{1 + \frac{{l}_{34}^{2}}{1 + \frac{{l}_{45}^{2}}{\begin{matrix}1 + ⋱ \\ ⋮ \\ 1 + \frac{{l}_{( n - 1 ) n}^{2}}{( β + 1 )}\end{matrix}}}} )}^{2}} \times \frac{1}{{( 1 + \frac{{l}_{34}^{2}}{1 + \frac{{l}_{45}^{2}}{\begin{matrix}1 + ⋱ \\ ⋮ \\ 1 + \frac{{l}_{( n - 1 ) n}^{2}}{( β + 1 )}\end{matrix}}} )}^{2}} \times \frac{1}{{( 1 + \frac{{l}_{45}^{2}}{\begin{matrix}1 + ⋱ \\ ⋮ \\ 1 + \frac{{l}_{( n - 1 ) n}^{2}}{( β + 1 )}\end{matrix}} )}^{2}} \times … \times \frac{1}{{( 1 + \frac{{l}_{( n - 1 ) n}^{2}}{( β + 1 )} )}^{2}} \times {( β + 1 )}^{2} \\ where {l}_{( n - 1 ) n}^{2} = {k}_{( n - 1 ) n}^{2} {Q}_{( n - 1 )} {Q}_{( n )} \qquad ( 39 )$$

The value of β that maximizes the efficiency for single repeater is given by Equation 36. The value of β that maximizes the efficiency for two receivers is:

$$β = \sqrt{\frac{( 1 + {k}_{23}^{2} {Q}_{2 int} {Q}_{3 int} + {k}_{34}^{2} {Q}_{3 int} {Q}_{4 int} ) ( \begin{matrix}1 + {k}_{12}^{2} {Q}_{1 int} {Q}_{2 int} + \\ {k}_{23}^{2} {Q}_{2 int} {Q}_{3 int} + {k}_{34}^{2} {Q}_{3 int} {Q}_{4 int} + \\ ( {k}_{12}^{2} {Q}_{1 int} {Q}_{2 int} ) ( {k}_{34}^{2} {Q}_{3 int} {Q}_{4 int} )\end{matrix} )}{( 1 + {k}_{23}^{2} {Q}_{2 int} {Q}_{3 int} ) ( 1 + {k}_{12}^{2} {Q}_{1 int} {Q}_{2 int} + {k}_{23}^{2} {Q}_{2 int} {Q}_{3 int} )}} \qquad ( 40 )$$

The value of β that maximizes the efficiency for a general case of ‘n−2’ repeaters is:

$$β = \sqrt{\frac{( num 1 ) ( num 2 )}{( den 1 ) ( den 2 )}} \\ Where \\ num 1 = 1 + {\sum }_{i = 1}^{n - 1} {l}_{i , i + 1}^{2} + {\sum }_{n > j > i + 1 > 1} {l}_{i , i + 1}^{2} + {l}_{j , j + 1}^{2} + {\sum }_{n > k > j + 1 > j > i + 1 > 1} {l}_{i , i + 1}^{2} {l}_{j , j + 1}^{2} {l}_{k , k + 1}^{2} + … \\ num 2 = 1 + {\sum }_{i = 2}^{n - 1} {l}_{i , i + 1}^{2} + {\sum }_{n > j > i + 1 > 2} {l}_{i , i + 1}^{2} + {l}_{j , j + 1}^{2} + {\sum }_{n > k > j + 1 > j > i + 1 > 2} {l}_{i , i + 1}^{2} {l}_{j , j + 1}^{2} {l}_{k , k + 1}^{2} + … \\ den 1 = 1 + {\sum }_{i = 2}^{n - 2} {l}_{i , i + 1}^{2} + {\sum }_{n - 1 > j > i + 1 > 2} {l}_{i , i + 1}^{2} + {l}_{j , j + 1}^{2} + {\sum }_{n - 1 > k > j + 1 > j > i + 1 > 2} {l}_{i , i + 1}^{2} {l}_{j , j + 1}^{2} {l}_{k , k + 1}^{2} + … \\ den 2 = 1 + {\sum }_{i = 2}^{n - 2} {l}_{i , i + 1}^{2} + {\sum }_{n - 1 > j > i + 1 > 1} {l}_{i , i + 1}^{2} + {l}_{j , j + 1}^{2} + {\sum }_{n - 1 > k > j + 1 > j > i + 1 > 1} {l}_{i , i + 1}^{2} {l}_{j , j + 1}^{2} {l}_{k , k + 1}^{2} + … \\ {l}_{i , i + 1}^{2} = {k}_{i , i + 1}^{2} {Q}_{( i )} {Q}_{( i + 1 )} \qquad ( 41 )$$

FIG. 21 illustrates the wireless power transmission network 2100 comprising a transmitter and two coupled receiver according to embodiments of the present disclosure. The embodiment of the wireless power transmission network shown in FIG. 21 is for illustration only. Other embodiments of wireless power transfer network could be used without departing from the scope of the present disclosure.

Because of the mutual coupling between the receiver devices, the impedance seen by the source as well as loads will be complex i.e., will have a real part as well as an imaginary part as indicated as follows:

$$\begin{matrix}{Z}_{source} = ( {Z}_{s} ) + \frac{{( ω {M}_{12} )}^{2} {Z}_{L 3}}{{( ω {M}_{23} )}^{2} + {Z}_{L 2} {Z}_{L 3}} + \frac{{( ω {M}_{13} )}^{2} {Z}_{L 2}}{{( ω {M}_{23} )}^{2} + {Z}_{L 2} {Z}_{L 3}} - j \frac{2 ( ω {M}_{12} ) ( ω {M}_{13} ) ( ω {M}_{23} )}{{( ω {M}_{23} )}^{2} + {Z}_{L 2} {Z}_{L 3}} & ( 42 ) \\ {Z}_{R \times 2} = ( {Z}_{2} ) + \frac{{( ω {M}_{13} )}^{2} {Z}_{L 2}}{{( ω {M}_{13} )}^{2} + {Z}_{S} {Z}_{L 3}} + \frac{{( ω {M}_{23} )}^{2} {Z}_{S}}{{( ω {M}_{13} )}^{2} + {Z}_{S} {Z}_{L 3}} - j \frac{2 ( ω {M}_{12} ) ( ω {M}_{13} ) ( ω {M}_{23} )}{{( ω {M}_{13} )}^{2} + {Z}_{S} {Z}_{L 3}} & ( 43 ) \\ {Z}_{R \times 3} = ( {Z}_{3} ) + \frac{{( ω {M}_{13} )}^{2} {Z}_{L 2}}{{( ω {M}_{12} )}^{2} + {Z}_{S} {Z}_{L 2}} + \frac{{( ω {M}_{23} )}^{2} {Z}_{S}}{{( ω {M}_{12} )}^{2} + {Z}_{S} {Z}_{L2}} - j \frac{2 ( ω {M}_{12} ) ( ω {M}_{13} ) ( ω {M}_{23} )}{{( ω {M}_{12} )}^{2} + {Z}_{S} {Z}_{L 2}} & ( 44 )\end{matrix}$$

In case of multiple receivers, since the mutual impedance terms can be positive or negative depending on the relative position and sense of inductive resonators/loops (clockwise/anticlockwise), therefore the reactive part of impedance seen by transmitter as well as receivers can be positive or negative. Hence, in addition to the impedance matching network at source and load devices, variable capacitor and inductor will be required to resonate out positive and negative reactance respectively.

At least some of the components in above embodiments can be implemented in software while other components may be implemented by configurable hardware or a mixture of software and configurable hardware. The configurable hardware may include at least one of a single FPGA device, processor, or ASIC, or a combination thereof.

It can be also contemplated that various combinations or sub-combinations of the specific features and aspects of the embodiments may be made and still fall within the scope of the appended claims. For example, in some embodiments, the features, configurations, or other details disclosed or incorporated by reference herein with respect to some of the embodiments are combinable with other features, configurations, or details disclosed herein with respect to other embodiments to form new embodiments not explicitly disclosed herein. All of such embodiments having combinations of features and configurations are contemplated as being part of the present disclosure. Additionally, unless otherwise stated, no features or details of any of the stent or connector embodiments disclosed herein are meant to be required or essential to any of the embodiments disclosed herein, unless explicitly described herein as being required or essential.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for wireless power transmission, the method comprising:
establishing respective wireless communication link between a coordinating transmitter and each receiver;
measuring respective mutual impedance between a coordinating transmitter and each receiver by applying a voltage to the coordinating transmitter and configuring each receiver to measure an induced current in response to the applied voltage;
calculating respective matching impedance for the coordinating transmitter and each receiver based on corresponding mutual impedance;
transmitting the respective matching impedance to each receiver to enable each receiver to adjust to have the respective matching impedance; and
adjusting the coordinating transmitter to have the respective matching impedance.

2. The method of claim 1, the method further comprising:
configuring each receiver to apply a voltage to each receiver to measure respective self-impedance of each receiver.

3. The method of claim 1, wherein during measuring features on each self-impedance each receiver sequentially is configured to apply a voltage to its inductive resonator and measure a corresponding current, and the other devices are configured to disconnect their loads from their inductive resonators.

4. The method of claim 3, wherein the coordinating transmitter is configured to transmit signals for each device either to apply a voltage to its inductive resonator or to disconnect its load from its inductive resonator.

5. The method of claim 4, wherein the signals include sequence digits for each receiver or time slots assigned to each device for applying a voltage to its circuit or disconnecting its load from its inductive resonator.

6. The method of claim 1, wherein during measuring each mutual impedance the coordinating transmitter is configured to apply a voltage to its inductive resonator and each receiver is configured to sequentially measure a corresponding current while other devices disconnect their loads from their inductive resonators.

7. The method of claim 6, wherein the coordinating transmitter is configured to transmit signals for each receiver either to apply a voltage to its inductive resonator or to disconnect its load from its inductive resonator.

8. The method of claim 7, wherein the signals include sequence digits for each receiver or time slots assigned to each device for applying a voltage to its inductive resonator or disconnecting its load from its inductive resonator.

9. The method of claim 1, the method further comprising:
detecting at least one trigger event to initiate an impedance matching operation.

10. The method of claim 9, wherein the at least one trigger event includes that a new receiver enters the wireless power transfer network.

11. The method of claim 10, wherein the at least at least one trigger event includes that an amount of a change of a Voltage Standing Wave Ratio (VSWR) at the coordinating transmitter is greater than a threshold.

12. The method of claim 1, wherein the matching impedances are calculated to accomplish a required power transfer efficiency.

13. The method of claim 1, wherein a ratio of source resistance to source inductive resonator loss resistance of Rₛ/R_{L1} and a ratio of load resistance to load inductive resonator loss resistance of Rₙ/R_{Ln} follows the following equation:
$$\frac{{R}_{S}}{{R}_{L 1}} = \frac{{R}_{2}}{{R}_{L 2}} = \frac{{R}_{3}}{{R}_{L 3}} = … = \frac{{R}_{n}}{{R}_{L n}} = γ = \sqrt{1 + {k}_{12}^{2} {Q}_{1 int} {Q}_{2 int} + {k}_{13}^{2} {Q}_{1 int} {Q}_{3 int} + … + {k}_{1 n}^{2} {Q}_{1 int} {Q}_{n int}}$$
$$where {Q}_{1 int} = \frac{ω {L}_{1}}{{R}_{L 1}} , {Q}_{n int} = \frac{ω {L}_{n}}{{R}_{L n}} , and {k}_{1 n} = \frac{ω {M}_{1 n}}{\sqrt{{L}_{1} {L}_{n}}} .$$

14. The method of claim 13, wherein an optimal power transfer efficiency is a sum of weighted individual power transferred efficiencies of each receiver.

15. The method of claim 1, wherein at least one receiver is a repeater located between the transmitter and the other receiver(s).

16. A coordinating transmitter for wireless power transmission, the coordinating transmitter comprising a processing circuitry configured to:
establish respective wireless communication link between the transmitter and each receiver;
measure respective mutual impedance between a coordinating transmitter and each receiver by applying a voltage to the coordinating transmitter and configuring each receiver to measure an induced current in response to the applied voltage;
calculate respective matching impedance for the coordinating transmitter and each receiver based on corresponding mutual impedance;
transmit the respective matching impedance to each receiver to enable each receiver to adjust to have the respective matching impedance; and
adjust the coordinating transmitter to have the respective matching impedance.

17. The coordinating transmitter of claim 16, wherein the processing circuitry configures each receiver to apply a voltage to each receiver to measure respective self-impedance of each receiver.

18. The coordinating transmitter of claim 16, wherein during measuring each internal-impedance each receiver is configured to sequentially apply a voltage to its circuit and measure currents corresponding to the voltage, and the other devices are configured to disconnect their loads from their inductive resonators.

19. The coordinating transmitter of claim 18, wherein the transmitter is configured to transmit signals for each device either to apply a voltage to its circuit or to disconnect its load from its inductive resonator.

20. The coordinating transmitter of claim 19, wherein the signals include sequence digits for each receiver or time slots assigned to each device for applying a voltage to their circuits or disconnecting their circuits.

21. The coordinating transmitter of claim 16, wherein during measuring respective mutual impedance the transmitter applies a voltage to its circuit and each receiver is configured to sequentially measure a corresponding current, and other devices are configured to disconnect their loads from their inductive resonators.

22. The coordinating transmitter of claim 21, wherein the transmitter is configured to transmit signals for each device either to apply a voltage to its circuit or to disconnect the circuit.

23. The coordinating transmitter of claim 22, wherein the signals include sequence digits for each receiver or time slots assigned to each device for applying a voltage to its circuit or disconnecting the circuit.

24. The coordinating transmitter of claim 16, the method further comprising:
detecting at least one trigger event to initiate matching impedances of the transmitter and each receiver.

25. The coordinating transmitter of claim 24, wherein the at least one trigger event includes that a new receiver enters the wireless power transfer network.

26. The coordinating transmitter of claim 25, wherein the at least at least one trigger event includes that an amount of a change of a Voltage Standing Wave Ratio (VSWR) at the transmitter is greater than a threshold.

27. The coordinating transmitter of claim 16, wherein each impedance for the transmitter and each receiver are calculated to accomplish an optimal resonant coupling efficiency.

28. The coordinating transmitter of claim 16, wherein a ratio of source resistance to source inductive resonator resistance of Rₛ/R_{L1} and a ratio of load resistance to load inductive resonator resistance of Rₙ/R_{Ln} follow the following equation:
$$\frac{{R}_{S}}{{R}_{L 1}} = \frac{{R}_{2}}{{R}_{L 2}} = \frac{{R}_{3}}{{R}_{L 3}} = … = \frac{{R}_{n}}{{R}_{L n}} = γ = \sqrt{1 + {k}_{12}^{2} {Q}_{1 int} {Q}_{2 int} + {k}_{13}^{2} {Q}_{1 int} {Q}_{3 int} + … + {k}_{1 n}^{2} {Q}_{1 int} {Q}_{n int}}$$
$$where {Q}_{1 int} = \frac{ω {L}_{1}}{{R}_{L 1}} , {Q}_{n int} = \frac{ω {L}_{n}}{{R}_{L n}} , and {k}_{1 n} = \frac{ω {M}_{1 n}}{\sqrt{{L}_{1} {L}_{n}}} .$$

29. The coordinating transmitter of claim 16, wherein optimal resonant coupling efficiency is a sum of weighted individual resonant coupling efficiencies of each receiver.

30. The coordinating transmitter of claim 16, wherein at least one repeater is located between the transmitter and each receiver.

31. A receiver for wireless power transmission, the receiver comprising a processing circuitry configured to:
establish a wireless communication link with a coordinating transmitter;
obtain information relating to a mutual impedance by measuring an induced current when the coordinating transmitter applies a voltage to its circuit;
transmit information relating to the mutual impedance to the coordinate transmitter;
receive a matching impedance from the coordinating transmitter; and
adjust the receiver to have the matching impedance.

32. The receiver of claim 31, wherein the processing circuitry is configured to apply a voltage to the receiver to measure a self-impedance.

33. The receiver of claim 31, wherein the transmitter is configured to transmit a signal for the receiver either to apply a voltage to its circuit or to disconnect its load from its inductive resonator.

34. The receiver of claim 31, wherein the signal include sequence digits or time slots assigned to the receiver, for applying a voltage to its circuit or disconnecting its load from its inductive resonator.

35. The receiver of claim 31, wherein during measuring the mutual impedance the transmitter is configured to apply a voltage to its circuit and the receiver is configured to measure a corresponding current.

36. The receiver of claim 31, wherein the transmitter is configured to transmit signals for the receiver either to apply a voltage to its circuit or to disconnect its load from its inductive resonator.

37. The receiver of claim 31, wherein the signals include sequence digits for the receiver or time slots assigned to the receiver for applying a voltage to its circuit or disconnecting its load from its inductive resonator.

38. The receiver of claim 31, wherein the controller is configured to detect at least one trigger event to initiate an operation for matching impedances of the transmitter and each receiver.

39. The receiver of claim 38, wherein the at least one trigger event includes that a new receiver enters the wireless power transfer network.

40. The receiver of claim 39, wherein the at least at least one trigger event includes that an amount of a change of a Voltage Standing Wave Ratio (VSWR) at the transmitter is greater than a threshold.

41. The receiver of claim 31, wherein the impedances for the transmitter and the receiver are calculated to accomplish an optimal resonant coupling efficiency.

42. The receiver of claim 31, wherein a ratio of source resistance to source inductive resonator resistance of Rₛ/R_{L1} and a ratio of load resistance to load inductive resonator resistance of R_{L}/R_{L2} follow the following equation:
$$\frac{{R}_{S}}{{R}_{L 1}} = \frac{{R}_{L}}{{R}_{L 2}} = γ = \sqrt{1 + {k}_{12}^{2} {Q}_{1 int} {Q}_{2 int}}$$
$$where {Q}_{1 int} = \frac{ω {L}_{1}}{{R}_{L 1}} , {Q}_{2 int} = \frac{ω {L}_{2}}{{R}_{L n}} , and {k}_{1 n} = \frac{ω {M}_{1 n}}{\sqrt{{L}_{1} {L}_{n}}} .$$

43. The receiver of claim 31, wherein optimal resonant coupling efficiency is a sum of weighted individual resonant coupling efficiencies of each receiver.

44. The receiver of claim 31, wherein at least one repeater is located between the transmitter and each receiver.

45. A method for wireless power transmission in a wireless power transfer network, the method comprising:
establishing respective wireless communication link between devices including a coordinating transmitter and at least one receiver;
measuring self-impedances of each device by configuring each device to switch to State-1, where the device applies a voltage to its inductive resonator and measure a respective current, and the other device(s) to switch to State-4, where its inductive resonator is open circuited;
measuring mutual impedances of the devices in pairs by switching one device of each pair to State-2, where the device applies a voltage to its inductive resonator, switching the other device of each pair is switched to State-3, where the device measures the current induced to its inductive resonator as a result of the voltage applied to the one device's inductive resonator, while a non-paired device(s) in the wireless power transfer network is switched to State-4, where its inductive resonator is open circuited;
configuring the receivers to transmit the respective applied voltage and measured induced current to the coordinating transmitter;
receiving, by the coordinating transmitter, the respective voltage and measured current from each device via the wireless communication link;
calculating respective matching impedance for the coordinating transmitter and each receiver based on corresponding self impedance and mutual impedance;
transmitting the respective matching impedance to each receiver to enable each receiver to adjust to have the respective matching impedance; and
adjusting the coordinating transmitter to have the respective matching impedance.
